(19) United States
(12) Patent Application Publication
(10) Pub. No.: US 2024/0200208 A1
(43) Pub. Date: Jun. 20, 2024

(54) CO2 PURIFICATION AND REDUCTION SYSTEMS

(71) Applicant: Twelve Benefit Corporation, Berkeley, CA (US)

(72) Inventors: Ziyang Huo, Moraga, CA (US); Yueshen Wu, Irvine, CA (US)

(21) Appl. No.: 18/509,058

(22) Filed: Nov. 14, 2023

Related U.S. Application Data
(60) Provisional application No. 63/386,054, filed on Dec. 5, 2022.

(51) Int. Cl. C25B 3/26; C25B 1/23; C25B 9/23; C25B 13/08; C25B 15/08

(52) U.S. Cl. CPC C25B 3/26; C25B 1/23; C25B 9/23; C25B 13/08; C25B 15/087

(57) ABSTRACT

A CO₂ purifier and a CO₂ electrolyzer may be integrated in a single electrochemical unit or cell having a bipolar plate separating the purifier and electrolyzer. In some embodiments, the electrochemical cell has a single positive electrical terminal attached to an anode of the CO₂ electrolyzer or the CO₂ purifier, and a single negative electrical terminal attached to a cathode of the CO₂ electrolyzer or the CO₂ purifier. In such implementations a bipolar plate may serve as a counter-electrode for both the CO₂ electrolyzer and the CO₂ purifier.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### FIELD

The present disclosure relates to integrated electrochemical cells for carbon dioxide enrichment and reduction.

### BACKGROUND

If left uncontrolled, greenhouse gas emissions such as carbon dioxide (CO₂) will have a significant impact on the climatic environment. The conversion of fossil fuels such as coal or natural gas into energy is a major source of greenhouse gas emissions. There is an urgent need for more effective management of CO₂ emissions and CO₂ already in the atmosphere. In addition to the need for improved CO₂ capture technologies there remains a need for improved CO₂ conversion technologies. Improvements in carbon capture technology whereby a stream of low-quality and/or low-concentration gas is converted to a stream of higher quality and/or higher concentration of gas is of great interest to manufacturing and energy industries where the gases are generated and to society at large.

### SUMMARY

The present disclosure relates to electrochemical cells for CO₂ enrichment and the integration of such cells with CO₂ electrolyzers.

Aspects of this disclosure pertain to systems that may be characterized by the following elements: (a) a first outer electrode of a first polarity; (b) a CO₂ purifier; (c) a second outer electrode configured to apply an electrical potential of a second polarity, opposite the first polarity; (d) a CO₂ electrolyzer configured to receive the purified CO₂ from the CO₂ purifier, the CO₂ electrolyzer; and (e) a bipolar plate separating the CO₂ purifier from the CO₂ electrolyzer.

The CO₂ purifier may include (i) an inlet for receiving impure CO_{2,} (ii) the first outer electrode configured to apply an electrical potential of a first polarity, (iii) a medium that selectively captures and/or removes CO₂ under the influence of a positive electrical potential or a negative electrical potential, and (iv) an outlet for removing purified CO_{2.} The CO₂ electrolyzer may include (i) an inlet for receiving the purified CO_{2,} (ii) the second outer electrode, and (iii) a cathode catalyst configured to electrochemically reduce CO₂ to produce a carbon containing product.

The bipolar plate may include (i) a first bipolar electrode surface of the second polarity for the CO₂ purifier, and (ii) a second bipolar electrode surface of the first polarity for the CO₂ electrolyzer. In some embodiments, the bipolar plate does not have an electrical connection to an external circuit or load.

The CO₂ purifier may have various features and functions. For example, the CO₂ purifier may be configured to produce the purified CO₂ while electrical energy is supplied to the first outer electrode and the second outer electrode. In some examples, the CO₂ purifier is configured to continuously produce the purified CO₂.

In some embodiments, the CO₂ purifier is configured to perform electrodialysis or related process. In some implementations, the CO₂ purifier includes a plurality of parallel liquid flow paths between the bipolar plate and the first outer electrode. The plurality of parallel liquid flow paths may include: a carbonate donating flow path configured to flow a first solution containing carbonate and/or bicarbonate ions wherein the carbonate donating flow path is bounded on a first side by an anion exchange membrane, and a carbonate receiving flow path arranged adjacent to said carbonate donating flow path and configured to flow a second solution that is more acidic than the first solution, wherein the carbonate receiving flow path is bounded by said anion exchange membrane that allows the carbonate and/or bicarbonate ions to pass from the carbonate donating flow path to the carbonate receiving flow path. In some embodiment, the medium includes the first solution and/or the second solution. In certain embodiments, the carbonate donating flow path is bounded on a second side by a bipolar membrane. In certain embodiments, the carbonate receiving flow path is bounded by a bipolar membrane. In certain embodiments, the plurality of parallel liquid flow paths include: a second carbonate donating flow path configured to flow the first solution; and a second carbonate receiving flow path arranged adjacent to said second carbonate donating flow path and configured to flow the second solution. In certain embodiments, the system includes a first solution tank configured to supply the first solution to the carbonate donating flow path and a recycle path configured to recycle the first solution from the carbonate donating flow path to the first solution tank. In certain embodiments, the system includes a second solution tank configured to supply the second solution to the carbonate receiving flow path and a recycle path configured to recycle the second solution from the carbonate receiving flow path to the second solution tank.

In some embodiments, the CO₂ purifier includes employs an electroactive polymer melt or solution that can flow between purifier's anode and cathode. In some cases, the CO₂ purifier includes (a) one or more flow paths configured transport a compound comprising one or more electroactive CO₂-absorbing moieties between an anode region and a cathode region, and (b) a controller configured to (i) apply a cathodic potential and/or flow a cathodic current to the cathode region to thereby cause the compound to absorb CO₂ from the impure CO_{2,} (ii) apply an anodic potential and/or flow an anodic current to the anode region to thereby cause the compound to release CO₂ and produce the purified CO_{2,} and (iii) cause the compound to move between the cathode region and the anode region. In certain embodiments, the CO₂ purifier further includes a separator between the cathode region and the anode region. In some embodiments, the compound includes one or more electroactive CO₂-absorbing moieties is a polymer. In some embodiments the one or more CO₂-absorbing moieties comprise quinone moieties.

The CO₂ electrolyzer may have various features and functions. For example, the CO₂ electrolyzer may include a membrane electrode assembly (MEA). In some examples, the MEA comprises an anion conducting polymer membrane. In some examples, the MEA further comprises a cation conducting polymer membrane in contact with the anion conducting polymer membrane. In some embodiments, the carbon containing product comprises CO, a hydrocarbon, formic acid, an alcohol, or any combination thereof.

In certain embodiments, the system includes a controller configured to cause electrical energy to be applied to the first outer electrode and the second outer electrode and thereby cause: (a) the CO₂ purifier to produce the purified CO_{2,} and (b) the cathode catalyst to electrochemically reduce the purified CO₂ to produce the carbon containing product.

In certain embodiments, the purified CO₂ has a concentration of at least about 20% by volume.

Aspects of this disclosure pertain to methods that may be characterized by the following operations: (a) receiving impure CO₂ in a CO₂ purifier; (b) selectively capturing and/or removing CO₂ under the influence of a positive electrical field or a negative electrical field in the CO₂ purifier; (c) providing purified CO₂ from the CO₂ purifier to a CO₂ electrolyzer; and (d) electrochemically reducing the purified CO₂ in the CO₂ electrolyzer to produce a carbon containing product. In some cases, such methods are implemented in a system comprising (a) a first outer electrode of a first polarity, (b) a second outer electrode of a second polarity, opposite the first polarity, (c) a CO₂ purifier having the first outer electrode as a CO₂ purifier anode or cathode, (d) a CO₂ electrolyzer having the second outer electrode as a CO₂ electrolyzer anode or cathode, and (e) a bipolar plate separating the CO₂ purifier from the CO₂ electrolyzer and arranged to provide (i) a first bipolar electrode surface of the second polarity for the CO₂ purifier, and (ii) a second bipolar electrode surface of the first polarity for the CO₂ electrolyzer. In some embodiments, the bipolar plate does not have an electrical connection to an external circuit or load.

In some embodiments, selectively capturing and/or removing CO₂ comprises supplying electrical energy to the first outer electrode and the second outer electrode. In some embodiments, the CO₂ purifier continuously provides the purified CO₂ to the CO₂ electrolyzer.

Some method embodiments pertain to CO₂ purifiers that comprise electrodialysis or related units with multiple parallel flow paths. In some such embodiments, the CO₂ purifier comprises a plurality of parallel liquid flow paths between the bipolar plate and the first outer electrode. The plurality of parallel liquid flow paths may include: (a) a carbonate donating flow path that flows a first solution containing carbonate and/or bicarbonate ions and is bounded on a first side by an anion exchange membrane, and (b) a carbonate receiving flow path adjacent to said carbonate donating flow path and flows a second solution that is more acidic than the first solution, wherein the carbonate receiving flow path is bounded by said anion exchange membrane that allows the carbonate and/or bicarbonate ions to pass from the carbonate donating flow path to the carbonate receiving flow path. In certain embodiments, the carbonate donating flow path is bounded on a second side by a bipolar membrane. In certain embodiments, the carbonate receiving flow path is bounded by a bipolar membrane. In some implementations, the plurality of parallel liquid flow paths further include: (c) a second carbonate donating flow path configured to flow the first solution; and (d) a second carbonate receiving flow path arranged adjacent to said second carbonate donating flow path and configured to flow the second solution. In some cases, the methods include: supplying the first solution to the carbonate donating flow path from a first solution tank; and recycling the first solution from the carbonate donating flow path to the first solution tank. In some cases, the methods include: supplying the second solution to the carbonate receiving flow path from a second solution tank; and recycling the second solution from the carbonate receiving flow path to the second solution tank.

Some method embodiments pertain to CO₂ purifiers that employ an electroactive polymer melt or solution that flows between anode and cathode. Some such embodiments include (a) transporting a compound comprising one or more electroactive CO₂-absorbing moieties between an anode region of the CO₂ purifier and a cathode region of the CO₂ purifier; (b) applying a cathodic potential and/or flowing a cathodic current to the cathode region to thereby cause the compound to absorb CO₂ from the impure CO_{2;} (c) applying an anodic potential and/or flowing an anodic current to the anode region to thereby cause the compound to release CO₂ and produce the purified CO_{2;} and (d) moving the compound between the cathode region and the anode region. In some embodiments, the CO₂ purifier includes a separator between the cathode region and the anode region. In some embodiments, the compound comprising one or more electroactive CO₂-absorbing moieties is a polymer. In some embodiments, the one or more CO₂-absorbing moieties comprise quinone moieties.

In certain embodiments, the CO₂ electrolyzer comprises an MEA. In certain embodiments, the MEA comprises an anion conducting polymer membrane. In certain embodiments, the MEA further comprises a cation conducting polymer membrane in contact with the anion conducting polymer membrane. In certain embodiments, the carbon containing product comprises CO, a hydrocarbon, formic acid, an alcohol, or any combination thereof.

In certain embodiments, methods include applying electrical energy to the first outer electrode and the second outer electrode and thereby cause: (i) the CO₂ purifier to produce the purified CO_{2,} and (ii) the CO₂ electrolyzer to electrochemically reduce the purified CO₂ to produce the carbon containing product.

In certain embodiments, the CO₂ purifier produces purified CO₂ having a concentration of at least about 20% by volume.

In the above-described aspects of the disclosure, any combination of the one or more dependent features may be implemented together with, or apart from, one another when used with the primary aspect. Additional aspects and features of the disclosure will be presented below, sometimes with reference to associated drawings.

### BRIEF DESCRIPTION OF THE DRAWINGS

FIG. 1A is a block diagram schematically illustrating components of an electrochemical CO₂ purifier employing a material having electroactive CO₂ capturing moieties.

FIG. 1B is a block diagram schematically illustrating components of a CO₂ purifier employing flowing acidic and basic solutions separated by ion exchange membranes.

FIG. 2 is a block diagram schematically illustrating systems integrating an electrochemical CO₂ purifier and a CO₂ electrolyzer.

FIG. 3A is a block diagram schematically illustrating a system integrating an electrochemical CO₂ purifier and a CO₂ electrolyzer. The CO₂ purifier employs a material having electroactive CO₂ capturing moieties.

FIG. 3B is a block diagram schematically illustrating a system integrating an electrochemical CO₂ purifier and a CO₂ electrolyzer. The CO₂ purifier employs flowing acidic and basic solutions separated by ion exchange membranes.

FIG. 4 depicts an example system for a carbon oxide reduction reactor that may include a cell comprising an MEA (membrane electrode assembly).

FIG. 5 depicts an example MEA for use in COₓ reduction. The MEA has a cathode

layer and an anode layer separated by an ion-conducting polymer layer.

### DETAILED DESCRIPTION

### Terminology

Unless defined otherwise, all technical and scientific terms used herein have the same meaning as commonly understood by one of ordinary skill in the art. The terms presented immediately below may be more fully understood by reference to the remainder of the specification. The following descriptions are presented to provide context and an introduction to the complex concepts described herein. These descriptions are not intended to limit the full scope of the disclosure.

An “electrochemical cell” comprises an anode, a cathode, and electrolyte between the anode and cathode. At least one of the anode and cathode can undergo, catalyze, or otherwise support a faradaic reaction. In an electrolytic electrochemical cell, an external circuit applies an electrical potential difference between the anode and cathode, and that potential difference drives the faradaic reaction(s). Examples include electrolyzers such as CO₂ electrolyzers and water electrolyzers. It also includes some forms of CO₂ purifiers, particularly those that employ faradaic reactions at an anode and/or a cathode.

A “carbon oxide” includes carbon dioxide (CO₂), carbon monoxide (CO), carbonate ions (CO₃²⁻), bicarbonate ions (HCO₃⁻), and any combinations thereof. Carbonate and bicarbonate ions may be viewed as ions that “carry” or “hold” CO₂ in form that can be dissolved, melted, or otherwise provided in a liquid form, at least temporarily.

A “mixture” contains two or more components and unless otherwise stated may contain components other than the identified components.

A “CO₂ purifier” is a device configured to purify CO₂ from an impure CO₂ source or feed stream. There are various types of CO₂ purifier that employ various operating principles. Some purifiers rely on a CO₂ sorbent that selectively binds to CO₂ under a first condition and releases purified CO₂ under second condition. Because these purifiers operate in different phases between which process conditions “swing,” such purifiers are sometimes referred to as “swing” devices. Examples include temperature swing devices, pressure swing devices, and electro-swing devices. Some purifiers do not employ swing conditions. Some examples of such purifiers employ electrochemical cells and/or electrodialysis cells. Because of its function, a CO₂ purifier is sometimes referred to as a CO₂ separator or as a CO₂ scrubber.

As used herein, the term “about” is understood to account for minor increases and/or decreases beyond a recited value, which changes do not significantly impact the desired function the parameter beyond the recited value(s). In some cases, “about” encompasses +/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

By “aliphatic” is meant a hydrocarbon group having at least one carbon atom to 50 carbon atoms (C₁₋₅₀), such as one to 25 carbon atoms (C₁₋₂₅), or one to ten carbon atoms (C₁₋₁₀), and which includes alkanes (or alkyl), alkenes (or alkenyl), alkynes (or alkynyl), including cyclic versions thereof, and further including straight- and branched-chain arrangements, and all stereo and position isomers as well. Such an aliphatic can be unsubstituted or substituted with one or more groups, such as groups described herein for an alkyl group.

The term “acyl,” or “alkanoyl,” as used interchangeably herein, represents an alkyl group, as defined herein, or hydrogen attached to the parent molecular group through a carbonyl group, as defined herein. This group is exemplified by formyl, acetyl, propionyl, butanoyl, and the like. The alkanoyl group can be substituted or unsubstituted. For example, the alkanoyl group can be substituted with one or more substitution groups, as described herein for alkyl. In some embodiments, the unsubstituted acyl group is a C₂₋₇ acyl or alkanoyl group. In particular embodiments, the alkanoyl group is —C(O)-Ak, in which Ak is an alkyl group, as defined herein.

By “alkoxy” is meant —OR, where R is an optionally substituted alkyl group, as described herein. Exemplary alkoxy groups include methoxy, ethoxy, butoxy, trihaloalkoxy, such as trifluoromethoxy, etc. The alkoxy group can be substituted or unsubstituted. For example, the alkoxy group can be substituted with one or more substitution groups, as described herein for alkyl. Exemplary unsubstituted alkoxy groups include C₁₋₃, C₁₋₆, C₁₋₁₂, C₁₋₁₆, C₁₋₁₈, C₁₋₂₀, or C₁₋₂₄ alkoxy groups.

By “alkoxyalkyl” is meant an alkyl group, as defined herein, which is substituted with an alkoxy group, as defined herein. Exemplary unsubstituted alkoxyalkyl groups include between 2 to 12 carbons (C2-12 alkoxyalkyl), as well as those having an alkyl group with 1 to 6 carbons and an alkoxy group with 1 to 6 carbons (i.e., C₁₋₆ alkoxy-C₁₋₆ alkyl).

By “alkyl” and the prefix “alk” is meant a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic (e.g., C₃₋₂₄ cycloalkyl) or acyclic. The alkyl group can be branched or unbranched. The alkyl group can also be substituted or unsubstituted. For example, the alkyl group can be substituted with one, two, three or, in the case of alkyl groups of two carbons or more, four substituents independently selected from the group consisting of: (1) C₁₋₆ alkoxy (e.g., —O-Ak, wherein Ak is optionally substituted C₁₋₆ alkyl); (2) C₁₋₆ alkylsulfinyl (e.g., —S(O)-Ak, wherein Ak is optionally substituted C₁₋₆ alkyl); (3) C₁₋₆ alkylsulfonyl (e.g., —SO₂-Ak, wherein Ak is optionally substituted C₁₋₆ alkyl); (4) amino (e.g., —NR^{N1}R^{N2}, where each of R^{N1} and R^{N2}is, independently, H or optionally substituted alkyl, or R^{N1} and R^{N2}, taken together with the nitrogen atom to which each are attached, form a heterocyclyl group); (5) aryl; (6) arylalkoxy (e.g., —O-L-Ar, wherein L is a bivalent form of optionally substituted alkyl and Ar is optionally substituted aryl); (7) aryloyl (e.g., —C(O)—Ar, wherein Ar is optionally substituted aryl); (8) azido (e.g., —N₃); (9) cyano (e.g., —CN); (10) carboxyaldehyde (e.g., —C(O)H); (11) C₃₋₈ cycloalkyl (e.g., a monovalent saturated or unsaturated non-aromatic cyclic C₃₋₈ hydrocarbon group); (12) halo (e.g., F, Cl, Br, or I); (13) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (14) heterocyclyloxy (e.g., —-O-Het, wherein Het is heterocyclyl, as described herein); (15) heterocyclyloyl (e.g., —C(O)-Het, wherein Het is heterocyclyl, as described herein); (16) hydroxyl (e.g., —OH); (17) N-protected amino; (18) nitro (e.g., —NO₂); (19) oxo (e.g., —O) or hydroxyimino (e.g., ═N—OH); (20) C₃₋₈ spirocyclyl (e.g., an alkylene or heteroalkylene diradical, both ends of which are bonded to the same carbon atom of the parent group); (21) C₁₋₆ thioalkoxy (e.g., —S-Ak, wherein Ak is optionally substituted C₁₋₆ alkyl); (22) thiol (e.g., —SH); (23) —CO₂R^{A}, where R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (24) —C(O)NRBRC, where each of RB and RC is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (25) —SO₂R^{D}, where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl group and Ar is optionally substituted aryl); (26) —SO₂NR^{E}R^{F}, where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); and (27) —NR^{G}R^{H}, where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., L-Ar, wherein L is a bivalent form of optionally substituted alkyl group and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl group and Cy is optionally substituted cycloalkyl, as described herein), wherein in one embodiment no two groups are bound to the nitrogen atom through a carbonyl group or a sulfonyl group. The alkyl group can be a primary, secondary, or tertiary alkyl group substituted with one or more substituents (e.g., one or more halo or alkoxy). In some embodiments, the unsubstituted alkyl group is a C₁₋₃, C₁₋₆, C₁₋₁₂, C₁₋₁₆, C₁₋₁₈, C₁₋₂₀, or C₁₋₂₄ alkyl group.

By “alkylene” is meant a multivalent (e.g., bivalent, trivalent, tetravalent, etc.) form of an alkyl group, as described herein. Exemplary alkylene groups include methylene, ethylene, propylene, butylene, etc. In some embodiments, the alkylene group is a C₁₋₃, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can be saturated or unsaturated (e.g., having one or more double bonds or triple bonds). The alkylene group can also be substituted or unsubstituted. For example, the alkylene group can be substituted with one or more substitution groups, as described herein for alkyl. In one instance, a substituted alkylene group can include an optionally substituted haloalkylene (e.g., an optionally substituted alkylene substituted with one or more hydroxyl groups, as defined herein), an optionally substituted haloalkylene (e.g., an optionally substituted alkylene substituted with one or more halo groups, as defined herein), and the like.

By “alkyleneoxy” is meant an alkylene group, as defined herein, attached to the parent molecular group through an oxygen atom.

By “amino” is meant —NR^{N1}R^{N2}, where each of RNI and R^{N2} is, independently, H, optionally substituted alkyl, optionally substituted cycloalkyl, or optionally substituted aryl; or R_{N1} and R^{N2}, taken together with the nitrogen atom to which each are attached, form an optionally substituted heterocyclyl group or heterocycle, as defined herein; or R^{N1} and R^{N2}, taken together, form an optionally substituted alkylene or heteroalkylene (e.g., as described herein).

By “aminoalkyl” is meant an alkyl group, as defined herein, substituted by an amino group, as defined herein. Non-limiting aminoalkyl groups include -L-NR^{N1}R^{N2}, where L is a multivalent alkyl group, as defined herein; each of R^{N1} and R^{N2} is, independently, H, optionally substituted alkyl, or optionally substituted aryl; or R^{N1} and R^{N2}, taken together with the nitrogen atom to which each are attached, form a heterocyclyl group, as defined herein.

By “ammonium” is meant a group including a protonated nitrogen atom N⁺. Exemplary ammonium groups include —N⁺R^{N1}R^{N2}R^{N3} where each of R^{N1}, R^{N2}, and RN³ is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl group or heterocycle; or R^{N1} and R^{N2}, taken together, form an optionally substituted alkylene or heteroalkylene (e.g., as described herein); or R^{N1} and R^{N2} and R^{N3}, taken together with the nitrogen atom to which each are attached, form an optionally substituted heterocyclyl group or heterocycle, such as a heterocyclic cation.

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized x-electron system. Typically, the number of out of plane x-electrons corresponds to the Huckel rule (4n+2). The point of attachment to the parent structure typically is through an aromatic portion of the condensed ring system. Such an aromatic can be unsubstituted or substituted with one or more groups, such as groups described herein for an alkyl or aryl group. Yet other substitution groups can include aliphatic, haloaliphatic, halo, nitrate, cyano, sulfonate, sulfonyl, or others.

By “aryl” is meant a group that contains any carbon-based aromatic group including, but not limited to, phenyl, benzyl, anthracenyl, anthryl, benzocyclobutenyl, benzocyclooctenyl, biphenylyl, chrysenyl, dihydroindenyl, fluoranthenyl, indacenyl, indenyl, naphthyl, phenanthryl, phenoxybenzyl, picenyl, pyrenyl, terphenyl, and the like, including fused benzo-C₄₋₈ cycloalkyl radicals (e.g., as defined herein) such as, for instance, indanyl, tetrahydronaphthyl, fluorenyl, and the like. The term aryl also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be substituted or unsubstituted. The aryl group can be substituted with one, two, three, four, or five substituents independently selected from the group consisting of: (1) C₁₋₆ alkanoyl (e.g., —C(O)-Ak, wherein Ak is optionally substituted C₁₋₆ alkyl); (2) C₁₋₆ alkyl; (3) C₁₋₆ alkoxy (e.g., —O-Ak, wherein Ak is optionally substituted C₁₋₆ alkyl); (4) C₁₋₆ alkoxy-C₁₋₆ alkyl (e.g., -L-O-Ak, wherein L is a bivalent form of optionally substituted alkyl group and Ak is optionally substituted C₁₋₆ alkyl); (5) C₁₋₆ alkylsulfinyl (e.g., —S(O)-Ak, wherein Ak is optionally substituted C₁₋₆ alkyl); (6) C₁₋₆ alkylsulfinyl-C₁₋₆ alkyl (e.g., -L-S(O)-Ak, wherein L is a bivalent form of optionally substituted alkyl group and Ak is optionally substituted C₁₋₆ alkyl); (7) C₁₋₆ alkylsulfonyl (e.g., —SO₂-Ak, wherein Ak is optionally substituted C₁₋₆ alkyl); (8) C₁₋₆ alkylsulfonyl-C₁₋₆ alkyl (e.g., -L-SO₂-Ak, wherein L is a bivalent form of optionally substituted alkyl group and Ak is optionally substituted C₁₋₆ alkyl); (9) aryl; (10) amino (e.g., —NR^{N1}R^{N2}, where each of R^{N1} and R^{N2} is, independently, H or optionally substituted alkyl, or R^{N1} and R^{N2}, taken together with the nitrogen atom to which each are attached, form a heterocyclyl group); (11) C₁₋₆ aminoalkyl (e.g., an alkyl group, as defined herein, substituted by one or more —NR^{N1}RN² groups, as described herein); (12) heteroaryl (e.g., a subset of heterocyclyl groups (e.g., a 5-, 6- or 7-membered ring, unless otherwise specified, containing one, two, three, or four non-carbon heteroatoms), which are aromatic); (13) (C₄₋₁₈ aryl) C₁₋₆ alkyl (e.g., -L-Ar, wherein L is a bivalent form of optionally substituted alkyl and Ar is optionally substituted aryl); (14) aryloyl (e.g., —C(O)—Ar, wherein Ar is optionally substituted aryl); (15) azido (e.g., —N₃); (16) cyano (e.g., —CN); (17) C₁₋₆ azidoalkyl (e.g., an alkyl group, as defined herein, substituted by one or more azido groups, as described herein); (18) carboxyaldehyde (e.g., —C(O)H); (19) carboxyaldehyde-C₁₋₆ alkyl (e.g., an alkyl group, as defined herein, substituted by one or more carboxyaldehyde groups, as described herein); (20) C₃₋₈ cycloalkyl (e.g., a monovalent saturated or unsaturated non-aromatic cyclic C₃₋₈ hydrocarbon group); (21) (C₃₋₈ cycloalkyl) C₁₋₆ alkyl (e.g., an alkyl group, as defined herein, substituted by one or more cycloalkyl groups, as described herein); (22) halo (e.g., F, Cl, Br, or I); (23) C₁₋₆ haloalkyl (e.g., an alkyl group, as defined herein, substituted by one or more halo groups, as described herein); (24) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (25) heterocyclyloxy (e.g., —O-Het, wherein Het is heterocyclyl, as described herein); (26) heterocyclyloyl (e.g., —C(O)-Het, wherein Het is heterocyclyl, as described herein); (27) hydroxyl (e.g., —OH); (28) C₁₋₆ hydroxyalkyl (e.g., an alkyl group, as defined herein, substituted by one or more hydroxyl, as described herein); (29) nitro (e.g., —NO₂); (30) C₁₋₆ nitroalkyl (e.g., an alkyl group, as defined herein, substituted by one or more nitro, as described herein); (31) N-protected amino; (32) N-protected amino-C₁₋₆ alkyl (e.g., an alkyl group, as defined herein, substituted by one or more N-protected amino groups); (33) oxo (e.g., ═O) or hydroxyimino (e.g., ═N—OH); (34) C₁₋₆ thioalkoxy (e.g., —S-Ak, wherein Ak is optionally substituted C₁₋₆ alkyl); (35) thio-C₁₋₆ alkoxy-C₁₋₆ alkyl (e.g., -L-S-Ak, wherein L is a bivalent form of optionally substituted alkyl and Ak is optionally substituted C₁₋₆ alkyl); (36) —(CH₂)ᵣCO₂R^{A}, where r is an integer of from zero to four, and R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (37) —(CH₂)ᵣCONR^{B}R^{C}, where r is an integer of from zero to four and where each R^{B} and R^{C} is independently selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (38) —(CH₂)ᵣSO₂R^{D}, where r is an integer of from zero to four and where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl and Ar is optionally substituted aryl); (39) —(CH₂)ᵣSO₂NR^{E}R^{F}, where r is an integer of from zero to four and where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (40) —(CH₂)ᵣNR^{G}R^{H}, where r is an integer of from zero to four and where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., -L-Ar, wherein L is a bivalent form of optionally substituted alkyl and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl and Cy is optionally substituted cycloalkyl, as described herein), wherein in one embodiment no two groups are bound to the nitrogen atom through a carbonyl group or a sulfonyl group; (41) thiol (e.g., —SH); (42) perfluoroalkyl (e.g., an alkyl group having each hydrogen atom substituted with a fluorine atom); (43) perfluoroalkoxy (e.g., —OR^{f}, where R^{f} is an alkyl group having each hydrogen atom substituted with a fluorine atom); (44) aryloxy (e.g., —OAr, where Ar is optionally substituted aryl); (45) cycloalkoxy (e.g., —O-Cy, wherein Cy is optionally substituted cycloalkyl, as described herein); (46) cycloalkylalkoxy (e.g., —O-L-Cy, wherein L is a bivalent form of optionally substituted alkyl and Cy is optionally substituted cycloalkyl, as described herein); and (47) arylalkoxy (e.g., —O-L-Ar, wherein L is a bivalent form of optionally substituted alkyl and Ar is optionally substituted aryl). In particular embodiments, an unsubstituted aryl group is a C₄₋₁₈, C₄₋₁₄, C₄₋₁₂, C₄₋₁₀, C₆₋₁₈, C₆₋₁₄, C₆₋₁₂, or C₆₋₁₀ aryl group.

By “arylalkoxy” is meant an arylalkylene group, as defined herein, attached to the parent molecular group through an oxygen atom. In some embodiments, the arylalkoxy group is —O-Ak-Ar, in which Ak is an optionally substituted alkylene, as defined herein, and Ar is an optionally substituted aryl, as defined herein.

By “(aryl)(alkyl)ene” is meant a bivalent form including an arylene group, as described herein, attached to an alkylene or a heteroalkylene group, as described herein. In some embodiments, the (aryl)(alkyl)ene group is -L-Ar— or -L-Ar-L- or —Ar-L-, in which Ar is an arylene group and each L is, independently, an optionally substituted alkylene group or an optionally substituted heteroalkylene group.

By “arylalkylene” is meant an aryl group, as defined herein, attached to the parent molecular group through an alkylene group, as defined herein. In some embodiments, the arylalkylene group is -Ak-Ar, in which Ak is an optionally substituted alkylene, as defined herein, and Ar is an optionally substituted aryl, as defined herein. The arylalkylene group can be substituted or unsubstituted. For example, the arylalkylene group can be substituted with one or more substitution groups, as described herein for aryl and/or alkyl. Exemplary unsubstituted arylalkylene groups are of from 7 to 16 carbons (C7-16 arylalkylene), as well as those having an aryl group with 4 to 18 carbons and an alkylene group with 1 to 6 carbons (i.e., (C₄₋₁₈ aryl)C₁₋₆ alkylene).

By “arylene” is meant a multivalent (e.g., bivalent, trivalent, tetravalent, etc.) form of an aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be substituted or unsubstituted. For example, the arylene group can be substituted with one or more substitution groups, as described herein for aryl.

By “aryleneoxy” is meant an arylene group, as defined herein, attached to the parent molecular group through an oxygen atom.

By “aryloxy” is meant —OR, where R is an optionally substituted aryl group, as described herein. In some embodiments, an unsubstituted aryloxy group is a C₄₋₁₈ or C₆₋₁₈ aryloxy group.

By “aryloyl” is meant an aryl group that is attached to the parent molecular group through a carbonyl group. In some embodiments, an unsubstituted aryloyl group is a C₇₋₁₁ aryloyl or C₅₋₁₉ aryloyl group. In particular embodiments, the aryloyl group is —C(O)—Ar, in which Ar is an aryl group, as defined herein.

By “boranyl” is meant a —BR₂ group, in which each R, independently, can be H, halo, or optionally substituted alkyl.

By “borono” is meant a —BOH₂ group.

By “carboxyl” is meant a —CO₂H group.

By “carboxylate anion” is meant a —CO₂⁻ group.

By “covalent bond” is meant a covalent bonding interaction between two components. Non-limiting covalent bonds include a single bond, a double bond, a triple bond, or a spirocyclic bond, in which at least two molecular groups are bonded to the same carbon atom.

By “cyano” is meant a —CN group.

By “cyclic group” is used herein to refer to either aryl groups, non-aryl groups (e.g., cycloalkyl or heterocycloalkyl groups), or both. Cyclic groups have one or more ring systems that can be substituted or unsubstituted. A cyclic group can contain one or more aryl groups, one or more non-aryl groups, or one or more aryl groups and one or more non-aryl groups.

By “cycloalkyl” is meant a monovalent saturated or unsaturated non-aromatic cyclic hydrocarbon group of from three to ten carbons (e.g., C₃₋₈ or C₃₋₁₀), unless otherwise specified, and is exemplified by cyclopropyl, cyclobutyl, cyclopentyl, cyclohexyl, cycloheptyl, bicyclo[2.2.1.]heptyl, and the like. The term cycloalkyl also includes “cycloalkenyl,” which is defined as a non-aromatic carbon-based ring composed of three to ten carbon atoms and containing at least one double bound, i.e., C—C. Examples of cycloalkenyl groups include, but are not limited to, cyclopropenyl, cyclobutenyl, cyclopentenyl, cyclopentadienyl, cyclohexenyl, cyclohexadienyl, and the like. The cycloalkyl group can also be substituted or unsubstituted. For example, the cycloalkyl group can be substituted with one or more groups including those described herein for alkyl.

By “halo” is meant F, Cl, Br, or I.

By “haloalkyl” is meant an alkyl group, as defined herein, substituted with one or more halo.

By “haloalkylene” is meant an alkylene group, as defined herein, substituted with one or more halo.

By “heteroaliphatic” is meant an aliphatic group, as defined herein, including at least one heteroatom to 20 heteroatoms, such as one to 15 heteroatoms, or one to 5 heteroatoms, which can be selected from, but not limited to oxygen, nitrogen, sulfur, silicon, boron, selenium, phosphorous, and oxidized forms thereof within the group.

By “heteroalkyl” is meant an alkyl group, as defined herein, containing one, two, three, or four non-carbon heteroatoms (e.g., independently selected from the group consisting of nitrogen, oxygen, phosphorous, sulfur, selenium, or halo).

By “heteroalkylene” is meant an alkylene group, as defined herein, containing one, two, three, or four non-carbon heteroatoms (e.g., independently selected from the group consisting of nitrogen, oxygen, phosphorous, sulfur, selenium, or halo). The heteroalkylene group can be saturated or unsaturated (e.g., having one or more double bonds or triple bonds). The heteroalkylene group can be substituted or unsubstituted. For example, the heteroalkylene group can be substituted with one or more substitution groups, as described herein for alkyl.

By “heteroaryl” is meant a subset of heterocyclyl groups, as defined herein, which are aromatic, i.e., they contain 4n+2 pi electrons within the mono- or multicyclic ring system.

The term “heterocycloalkyl” is a type of cycloalkyl group as defined above where at least one of the carbon atoms and its attached hydrogen atoms, if any, are replaced by O, S, N, or NH. The heterocycloalkyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described herein.

By “heterocycle” is meant a compound having one or more heterocyclyl moieties. Non-limiting heterocycles include optionally substituted imidazole, optionally substituted triazole, optionally substituted tetrazole, optionally substituted pyrazole, optionally substituted imidazoline, optionally substituted pyrazoline, optionally substituted imidazolidine, optionally substituted pyrazolidine, optionally substituted pyrrole, optionally substituted pyrroline, optionally substituted pyrrolidine, optionally substituted tetrahydrofuran, optionally substituted furan, optionally substituted thiophene, optionally substituted oxazole, optionally substituted isoxazole, optionally substituted isothiazole, optionally substituted thiazole, optionally substituted oxathiolane, optionally substituted oxadiazole, optionally substituted thiadiazole, optionally substituted sulfolane, optionally substituted succinimide, optionally substituted thiazolidinedione, optionally substituted oxazolidone, optionally substituted hydantoin, optionally substituted pyridine, optionally substituted piperidine, optionally substituted pyridazine, optionally substituted piperazine, optionally substituted pyrimidine, optionally substituted pyrazine, optionally substituted triazine, optionally substituted pyran, optionally substituted pyrylium, optionally substituted tetrahydropyran, optionally substituted dioxine, optionally substituted dioxane, optionally substituted dithiane, optionally substituted trithiane, optionally substituted thiopyran, optionally substituted thiane, optionally substituted oxazine, optionally substituted morpholine, optionally substituted thiazine, optionally substituted thiomorpholine, optionally substituted cytosine, optionally substituted thymine, optionally substituted uracil, optionally substituted thiomorpholine dioxide, optionally substituted indene, optionally substituted indoline, optionally substituted indole, optionally substituted isoindole, optionally substituted indolizine, optionally substituted indazole, optionally substituted benzimidazole, optionally substituted azaindole, optionally substituted azaindazole, optionally substituted pyrazolopyrimidine, optionally substituted purine, optionally substituted benzofuran, optionally substituted isobenzofuran, optionally substituted benzothiophene, optionally substituted benzisoxazole, optionally substituted anthranil, optionally substituted benzisothiazole, optionally substituted benzoxazole, optionally substituted benzthiazole, optionally substituted benzthiadiazole, optionally substituted adenine, optionally substituted guanine, optionally substituted tetrahydroquinoline, optionally substituted dihydroquinoline, optionally substituted dihydroisoquinoline, optionally substituted quinoline, optionally substituted isoquinoline, optionally substituted quinolizine, optionally substituted quinoxaline, optionally substituted phthalazine, optionally substituted quinazoline, optionally substituted cinnoline, optionally substituted naphthyridine, optionally substituted pyridopyrimidine, optionally substituted pyridopyrazine, optionally substituted pteridine, optionally substituted chromene, optionally substituted isochromene, optionally substituted chromenone, optionally substituted benzoxazine, optionally substituted quinolinone, optionally substituted isoquinolinone, optionally substituted carbazole, optionally substituted dibenzofuran, optionally substituted acridine, optionally substituted phenazine, optionally substituted phenoxazine, optionally substituted phenothiazine, optionally substituted phenoxathiine, optionally substituted quinuclidine, optionally substituted azaadamantane, optionally substituted dihydroazepine, optionally substituted azepine, optionally substituted diazepine, optionally substituted oxepane, optionally substituted thiepine, optionally substituted thiazepine, optionally substituted azocane, optionally substituted azocine, optionally substituted thiocane, optionally substituted azonane, optionally substituted azecine, etc. Optional substitutions include any described herein for aryl. Heterocycles can also include cations and/or salts of any of these (e.g., any described herein, such as optionally substituted piperidinium, optionally substituted pyrrolidinium, optionally substituted pyrazolium, optionally substituted imidazolium, optionally substituted pyridinium, optionally substituted quinolinium, optionally substituted isoquinolinium, optionally substituted acridinium, optionally substituted phenanthridinium, optionally substituted pyridazinium, optionally substituted pyrimidinium, optionally substituted pyrazinium, optionally substituted phenazinium, or optionally substituted morpholinium).

By “heterocyclyl” is meant a 3-, 4-, 5-, 6- or 7-membered ring (e.g., a 5-, 6- or 7-membered ring), unless otherwise specified, containing one, two, three, or four non-carbon heteroatoms (e.g., independently selected from the group consisting of nitrogen, oxygen, phosphorous, sulfur, selenium, or halo). The 3-membered ring has zero to one double bonds, the 4- and 5-membered ring has zero to two double bonds, and the 6- and 7-membered rings have zero to three double bonds. The term “heterocyclyl” also includes bicyclic, tricyclic and tetracyclic groups in which any of the above heterocyclic rings is fused to one, two, or three rings independently selected from the group consisting of an aryl ring, a cyclohexane ring, a cyclohexene ring, a cyclopentane ring, a cyclopentene ring, and another monocyclic heterocyclic ring, such as indolyl, quinolyl, isoquinolyl, tetrahydroquinolyl, benzofuryl, benzothienyl and the like. Heterocyclics include acridinyl, adenyl, alloxazinyl, azaadamantanyl, azabenzimidazolyl, azabicyclononyl, azacycloheptyl, azacyclooctyl, azacyclononyl, azahypoxanthinyl, azaindazolyl, azaindolyl, azecinyl, azepanyl, azepinyl, azetidinyl, azetyl, aziridinyl, azirinyl, azocanyl, azocinyl, azonanyl, benzimidazolyl, benzisothiazolyl, benzisoxazolyl, benzodiazepinyl, benzodiazocinyl, benzodihydrofuryl, benzodioxepinyl, benzodioxinyl, benzodioxanyl, benzodioxocinyl, benzodioxolyl, benzodithiepinyl, benzodithiinyl, benzodioxocinyl, benzofuranyl, benzophenazinyl, benzopyranonyl, benzopyranyl, benzopyrenyl, benzopyronyl, benzoquinolinyl, benzoquinolizinyl, benzothiadiazepinyl, benzothiadiazolyl, benzothiazepinyl, benzothiazocinyl, benzothiazolyl, benzothienyl, benzothiophenyl, benzothiazinonyl, benzothiazinyl, benzothiopyranyl, benzothiopyronyl, benzotriazepinyl, benzotriazinonyl, benzotriazinyl, benzotriazolyl, benzoxathiinyl, benzotrioxepinyl, benzoxadiazepinyl, benzoxathiazepinyl, benzoxathiepinyl, benzoxathiocinyl, benzoxazepinyl, benzoxazinyl, benzoxazocinyl, benzoxazolinonyl, benzoxazolinyl, benzoxazolyl, benzylsultamyl benzylsultimyl, bipyrazinyl, bipyridinyl, carbazolyl (e.g., 4H-carbazolyl), carbolinyl (e.g., β-carbolinyl), chromanonyl, chromanyl, chromenyl, cinnolinyl, coumarinyl, cytdinyl, cytosinyl, decahydroisoquinolinyl, decahydroquinolinyl, diazabicyclooctyl, diazetyl, diaziridinethionyl, diaziridinonyl, diaziridinyl, diazirinyl, dibenzisoquinolinyl, dibenzoacridinyl, dibenzocarbazolyl, dibenzofuranyl, dibenzophenazinyl, dibenzopyranonyl, dibenzopyronyl (xanthonyl), dibenzoquinoxalinyl, dibenzothiazepinyl, dibenzothiepinyl, dibenzothiophenyl, dibenzoxepinyl, dihydroazepinyl, dihydroazetyl, dihydrofuranyl, dihydrofuryl, dihydroisoquinolinyl, dihydropyranyl, dihydropyridinyl, dihydroypyridyl, dihydroquinolinyl, dihydrothienyl, dihydroindolyl, dioxanyl, dioxazinyl, dioxindolyl, dioxiranyl, dioxenyl, dioxinyl, dioxobenzofuranyl, dioxolyl, dioxotetrahydrofuranyl, dioxothiomorpholinyl, dithianyl, dithiazolyl, dithienyl, dithiinyl, furanyl, furazanyl, furoyl, furyl, guaninyl, homopiperazinyl, homopiperidinyl, hypoxanthinyl, hydantoinyl, imidazolidinyl, imidazolinyl, imidazolyl, indazolyl (e.g., 1H-indazolyl), indolenyl, indolinyl, indolizinyl, indolyl (e.g., 1H-indolyl or 3H-indolyl), isatinyl, isatyl, isobenzofuranyl, isochromanyl, isochromenyl, isoindazoyl, isoindolinyl, isoindolyl, isopyrazolonyl, isopyrazolyl, isoxazolidiniyl, isoxazolyl, isoquinolinyl, isoquinolinyl, isothiazolidinyl, isothiazolyl, morpholinyl, naphthindazolyl, naphthindolyl, naphthiridinyl, naphthopyranyl, naphthothiazolyl, naphthothioxolyl, naphthotriazolyl, naphthoxindolyl, naphthyridinyl, octahydroisoquinolinyl, oxabicycloheptyl, oxauracil, oxadiazolyl, oxazinyl, oxaziridinyl, oxazolidinyl, oxazolidonyl, oxazolinyl, oxazolonyl, oxazolyl, oxepanyl, oxetanonyl, oxetanyl, oxetyl, oxtenayl, oxindolyl, oxiranyl, oxobenzoisothiazolyl, oxochromenyl, oxoisoquinolinyl, oxoquinolinyl, oxothiolanyl, phenanthridinyl, phenanthrolinyl, phenazinyl, phenothiazinyl, phenothienyl (benzothiofuranyl), phenoxathiinyl, phenoxazinyl, phthalazinyl, phthalazonyl, phthalidyl, phthalimidinyl, piperazinyl, piperidinyl, piperidonyl (e.g., 4-piperidonyl), pteridinyl, purinyl, pyranyl, pyrazinyl, pyrazolidinyl, pyrazolinyl, pyrazolopyrimidinyl, pyrazolyl, pyridazinyl, pyridinyl, pyridopyrazinyl, pyridopyrimidinyl, pyridyl, pyrimidinyl, pyrimidyl, pyronyl, pyrrolidinyl, pyrrolidonyl (e.g., 2-pyrrolidonyl), pyrrolinyl, pyrrolizidinyl, pyrrolyl (e.g., 2H-pyrrolyl), pyrylium, quinazolinyl, quinolinyl, quinolizinyl (e.g., 4H-quinolizinyl), quinoxalinyl, quinuclidinyl, selenazinyl, selenazolyl, selenophenyl, succinimidyl, sulfolanyl, tetrahydrofuranyl, tetrahydrofuryl, tetrahydroisoquinolinyl, tetrahydroisoquinolyl, tetrahydropyridinyl, tetrahydropyridyl (piperidyl), tetrahydropyranyl, tetrahydropyronyl, tetrahydroquinolinyl, tetrahydroquinolyl, tetrahydrothienyl, tetrahydrothiophenyl, tetrazinyl, tetrazolyl, thiadiazinyl (e.g., 6H-1,2,5-thiadiazinyl or 2H,6H-1,5,2-dithiazinyl), thiadiazolyl, thianthrenyl, thianyl, thianaphthenyl, thiazepinyl, thiazinyl, thiazolidinedionyl, thiazolidinyl, thiazolyl, thienyl, thiepanyl, thiepinyl, thietanyl, thietyl, thiiranyl, thiocanyl, thiochromanonyl, thiochromanyl, thiochromenyl, thiodiazinyl, thiodiazolyl, thioindoxyl, thiomorpholinyl, thiophenyl, thiopyranyl, thiopyronyl, thiotriazolyl, thiourazolyl, thioxanyl, thioxolyl, thymidinyl, thyminyl, triazinyl, triazolyl, trithianyl, urazinyl, urazolyl, uretidinyl, uretinyl, uricyl, uridinyl, xanthenyl, xanthinyl, xanthionyl, and the like, as well as modified forms thereof (e.g., including one or more oxo and/or amino) and salts thereof. The heterocyclyl group can be substituted or unsubstituted. For example, the heterocyclyl group can be substituted with one or more substitution groups, as described herein for aryl.

By “heterocyclyldiyl” is meant a bivalent form of a heterocyclyl group, as described herein. In one instance, the heterocyclyldiyl is formed by removing a hydrogen from a heterocyclyl group. Exemplary heterocyclyldiyl groups include piperdylidene, quinolinediyl, etc. The heterocyclyldiyl group can also be substituted or unsubstituted. For example, the heterocyclyldiyl group can be substituted with one or more substitution groups, as described herein for heterocyclyl.

By “hydroxyl” is meant an —OH group.

By “hydroxyalkyl” is meant an alkyl group, as defined herein, substituted with one or more hydroxyl.

By “hydroxyalkylene” is meant an alkylene group, as defined herein, substituted with one or more hydroxy.

By “nitro” is meant an —NO₂ group.

By “phosphate” is meant a group derived from phosphoric acid. One example of phosphate includes a —O—P(═O)(OR^{P1})(OR^{P2}) or —O—[P(═O)(OR^{P1})—O]_{P3}—R^{P2} group, where each of R^{P1} and R^{P2}, is, independently, H, optionally substituted alkyl, optionally substituted alkenyl, optionally substituted aryl, or optionally substituted arylalkylene, and where P3 is an integer from 1 to 5. Yet other examples of phosphate include orthophosphoric acid, pyrophosphoric acid, tripolyphosphoric acid, tetrapolyphosphoric acid, trimetaphosphoric acid, and/or phosphoric anhydride, or combinations thereof.

By “phosphono” or “phosphonic acid” is meant a —P(O)(OH)₂ group.

By “spirocyclyl” is meant an alkylene diradical, both ends of which are bonded to the same carbon atom of the parent group to form a spirocyclyl group and also a heteroalkylene diradical, both ends of which are bonded to the same atom. Non-limiting alkylene and heteroalkylene groups for use within a spirocyclyl group includes C₂₋₁₂, C₂₋₁₁, C₂₋₁₀, C₂₋₉, C₂₋₈, C₂₋₇, C₂₋₆, C₂₋₅, C₂₋₄, or C₂₋₃ alkylene groups, as well as C₁₋₁₂, C₁₋₁₁, C₁₋₁₀, C₁₋₉, C₁₋₈, C₁₋₇, C₁₋₆, C₁₋₅, C₁₋₄, C₁₋₃, or C₁₋₂ heteroalkylene groups having one or more heteroatoms.

By “sulfate” is meant a group derived from sulfuric acid. One example of sulfate includes a —O—S(═O)₂(OR^{S1}) group, where R^{SI} is H, optionally substituted alkyl, optionally substituted alkenyl, optionally substituted aryl, or optionally substituted arylalkylene.

By “sulfo” or “sulfonic acid” is meant an —S(O)₂OH group.

By “sulfonyl” is meant an —S(O)₂— or —S(O)₂R group, in which R can be H, optionally substituted alkyl, or optionally substituted aryl. Non-limiting sulfonyl groups can include a trifluoromethylsulfonyl group (—SO₂—CF₃ or Tf).

By “thiocyanato” is meant an —SCN group.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S M et al., “Pharmaceutical salts,” J. Pharm. Sci. 1977 January; 66(1): 1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt). Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like. Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine. Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium). Yet other salts can include an anion, such as a halide (e.g., F⁻, Cl⁻, Br⁻, or I⁻), a hydroxide (e.g., OH⁻), a borate (e.g., tetrafluoroborate (BF₄⁻), a carbonate (e.g., CO₃²⁻ or HCO₃⁻), or a sulfate (e.g., SO₄²).

By “leaving group” is meant an atom (or a group of atoms) with electron withdrawing ability that can be displaced as a stable species, taking with it the bonding electrons, or an atom (or a group of atoms) that can be replaced by a substitution reaction. Examples of suitable leaving groups include H, halides, and sulfonates including, but not limited to, triflate (-OTf), mesylate (-OMs), tosylate (-OTs), brosylate (-OBs), acetate, Cl, Br, and I.

By “attaching,” “attachment,” or related word forms is meant any covalent or non-covalent bonding interaction between two components. Non-covalent bonding interactions include, without limitation, hydrogen bonding, ionic interactions, halogen bonding, electrostatic interactions, π bond interactions, hydrophobic interactions, inclusion complexes, clathration, van der Waals interactions, and combinations thereof.

### Introduction and Context

Aspects of this disclosure relate to integration of a CO₂ purifier with a CO₂ electrolyzer. In operation, the CO₂ purifier selectively captures CO₂ from a gas stream and then releases purified CO₂ as an output. The purified CO₂ is then provided as an input to the cathode of the CO₂ electrolyzer. The CO₂ electrolyzer can electrochemically reduce the CO₂ to a carbon-containing product (CCP) that may be stored, consumed, used to synthesize a valuable product, etc. The CO₂ purifier may employ electrical energy to drive or otherwise facilitate the CO₂ purification.

The CO₂ purifier and the CO₂ electrolyzer may be integrated in a single electrochemical unit or cell having a bipolar plate separating the purifier and electrolyzer. In some embodiments, the electrochemical cell has a single positive electrical terminal attached to an anode of the CO₂ electrolyzer or the CO₂ purifier, and a single negative electrical terminal attached to a cathode of the CO₂ electrolyzer or the CO₂ purifier. In such implementations a bipolar plate may have a dual purpose, serving as a counter-electrode for both the CO₂ electrolyzer and the CO₂ purifier. As an example, the electrochemical cell may have a single positive electrical terminal attached to an anode of the CO₂ electrolyzer and a single negative electrical terminal attached to a cathode of the CO₂ purifier. In such implementations a bipolar plate may have a dual purpose, serving as both a negative electrode for the CO₂ electrolyzer and a positive electrode for the CO₂ purifier. As another example, the electrochemical cell may have a single positive electrical terminal attached to an anode of the CO₂ purifier and a single negative electrical terminal attached to a cathode of the CO₂ electrolyzer, with a bipolar plate serving as a negative electrode for the CO₂ purifier and a positive electrode for the CO₂ electrolyzer. In some cases, the bipolar plate may have no electrical connection to an external power source or other circuit element. Various examples of these configurations will be described below.

In certain embodiments, an electrochemical system with a bipolar plate can be characterized as having two terminals or two terminal electrodes straddling two electrochemical cells, which are separated by the bipolar plate. In some embodiments, the electrochemical cells are a CO₂ purifier and a CO₂ electrolyzer.

Various types of electrochemical CO₂ purifier may be employed. In some embodiments, the purifier comprises an electrochemical cell having an anode and a cathode. The electrochemical cell may employ a polymer or other material that selectively captures CO₂ and subsequently releases the CO_{2.} The electrochemical cell may alternatively or additionally employ non-polymeric and/or inorganic components for capturing and releasing CO_{2.} For example, the cell may employ a basic aqueous solution for capturing CO₂ and an acidic aqueous solution for releasing CO₂.

Typically, the purifier allows at least some non-CO₂ inlet components to pass without capture. Depending on the composition of the inlet stream, examples of uncaptured components include water, nitrogen, carbon monoxide, oxygen, sulfur-containing compounds, and the like.

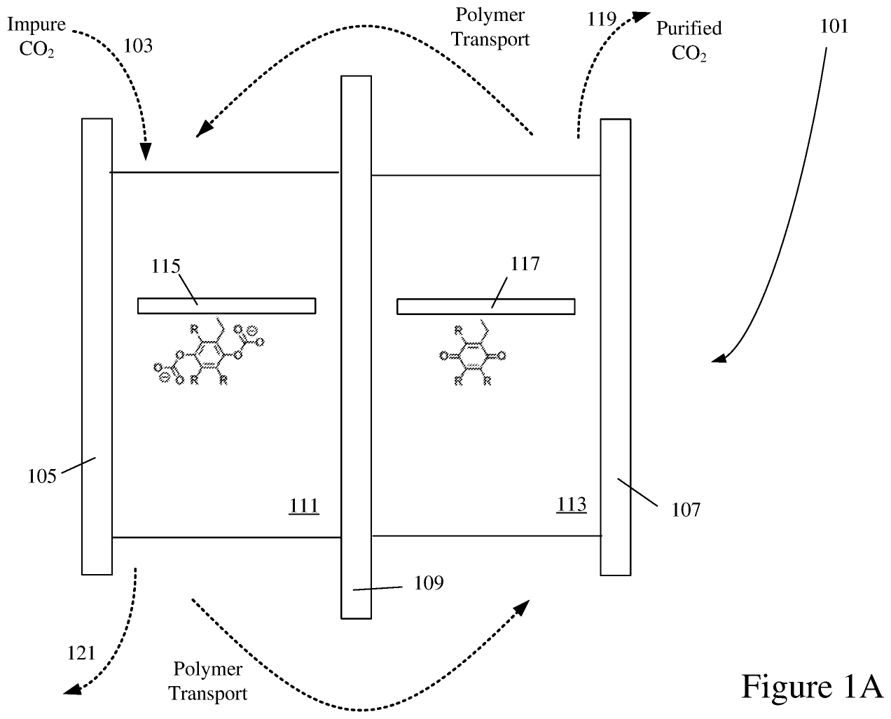

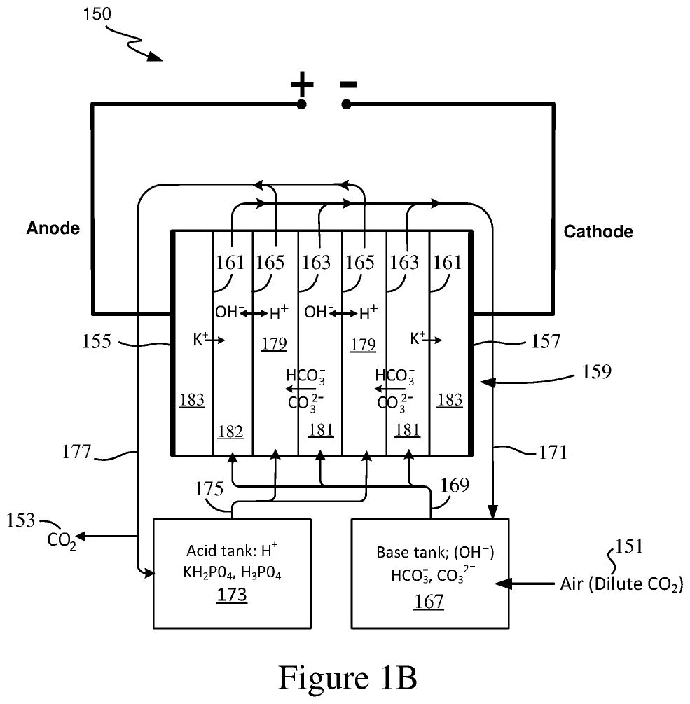

FIGS. 1A and 1B illustrate examples of integrated systems containing a CO₂ purifier and a CO₂ electrolyzer. These examples are described below. However, examples of CO₂ purifiers will be described first.

### CO₂ Purifiers

The CO₂ purifiers used in integrated purifier-electrolyzer cells may have many different designs and configurations. In some embodiments, a CO₂ purifier is electrically or electrochemically driven. Generally, the purifiers employ two electrodes, and, in operation, the two electrodes maintain an electrical potential difference within the purifier. The potential difference facilitates capture of CO₂ from an impure stream and release of CO₂ in a purified form.

In some approaches, the electrical potential of one electrode facilitates selective capture of CO₂ (to the exclusion of one or more other components) in an impure CO₂ stream, and the electrical potential of another electrode facilitates release of the captured-and now purified-CO_{2.} As an example, a negatively charged electrode may capture CO₂ through reduction to a carbonate ion or bicarbonate ion and/or by electrochemical reaction with an organic moiety such as a quinone moiety.

In some approaches, the electrical potential facilitates electrical migration of CO₂-containing species such as carbonate ions and/or bicarbonate ions across ion-selective membranes such as anion exchange membranes. This migration may move the CO₂ -containing species from a first environment in which the species are stable to a second environment (on the destination side of the membrane) where the species are unstable. The second environment facilitates release of gaseous CO₂. For example, bicarbonate ions may be transported by an electrical potential from a basic environment where they are stable to an acidic environment where they decompose to CO₂. An anion exchange membrane may separate the basic and acidic environments.

In various embodiments, a CO₂ purifier is characterized by the following elements: (i) a first terminal electrode configured to operate at a first polarity; (ii) an inlet for receiving impure CO₂, (iii) a medium that selectively captures and/or removes CO₂ under the influence of a positive electrical potential or a negative electrical potential, (iv) an outlet for removing purified CO₂; and (v) a surface or a portion of a bipolar plate separating the CO₂ purifier from a CO₂ electrolyzer and configured to provide a bipolar electrode surface of a second polarity, opposite the first polarity, for the CO₂ purifier. In certain embodiments, the CO₂ purifier is configured to produce the purified CO₂ while electrical energy is supplied to the first terminal electrode, which facilitates flow of ions in the medium of the CO₂ purifier.

In certain embodiments, the CO₂ purifier is configured to continuously produce the purified CO₂. In such embodiments, the electrodes of the purifier may operate at a consistent polarity, e.g., neither electrode switches from positive to negative, or vice versa, during a significant fraction of the operating period. This should be distinguished from the case of an “electro-swing” purifier in which the electrical potentials of the electrodes swing between positive and negative periods. For example, an electro-swing purifier may employ a CO₂-capturing medium on an electrode, and swing the electrode potential from negative, where the medium captures CO₂, and positive where the medium releases CO₂.

CO₂ purifiers employed in certain embodiments herein may maintain electrodes at a constant or substantially constant polarity but cause a CO₂-absorbing medium to flow between the electrodes. In certain embodiments, a CO₂ -absorbing medium flows in a direction transverse to the direction of the electrodes, but the electrical potential causes charged, CO₂ -containing species (e.g., bicarbonate ions) to flow toward a positively charged electrode and cross an ion-exchange membrane.

In certain embodiments, a CO₂ purifier removes CO₂ from air or another source stream and provides two outlet streams: a purified CO₂ stream and a CO₂-depleted outlet stream. The CO₂ purifier may operate in a continuous mode: i.e., it may provide a continuous stream of purified CO₂.

In some embodiments, a CO₂ purifier employs a polymer, ionic liquid, or other medium comprising electroactive, CO₂-binding moieties. These moieties may selectively react with CO₂ to form carbonate or other derivative moieties when exposed to an electrochemical reducing environment and release carbon dioxide when exposed to an electrochemical oxidizing environment. The medium may selectively capture CO₂ under the influence of a negative electrical potential and release captured CO₂ under the influence of a positive electrical potential.

In a CO₂ binding phase, the medium with electroactive, CO₂-binding moieties exists in an oxidized state, able to capture CO₂. The medium in this state is brought in contact with or proximity to an electrode providing a cathodic potential or current. When carbon dioxide from an impure CO₂ stream contacts the electrode, the CO₂ in the stream selectively reacts with the electroactive moieties. As a consequence, CO₂ is selectively removed from the impure CO₂ stream.

In a CO₂ release phase, the CO₂-binding moieties exist in a reduced state, able to release CO₂. The medium in this state is brought in contact with or proximity to an electrode providing an anodic potential or current. In this environment, the anodic potential oxidizes the moieties to release the carbon dioxide. As a consequence, CO₂ is released. Because the CO₂-binding moieties have not bound other components beside CO₂ in the inlet stream, the CO₂ released from the purifier has increased purity compared with the carbon dioxide in the inlet stream.

FIG. 1A presents an embodiment of a CO₂ purifier 101 configured for continuous purification of CO₂ from an impure input stream 103. The depicted CO₂ purifier includes a cathode 105, an anode 107, and an electronically insulating, ionically conducting separator 109. In this embodiment, separator 109 divides purifier 101 into a cathode compartment 111 and an anode compartment 113. Both compartments contain a polymer, ionic liquid, or other component with CO₂-absorbing electroactive moieties such as quinone moieties. The CO₂-absorbing electroactive moieties undergo a reaction with CO₂ in cathode compartment 111 to produce carbonate moieties. The CO₂-absorbing electroactive moieties undergo an oxidation reaction in anode compartment 113 to convert carbonate moieties to free CO₂.

The component having carbonate moieties is depicted as 115 and the component having quinone moieties is depicted as 117. In some embodiments, each R substituent on the depicted quinone moiety may independently represent a cyano, halo, aliphatic (such as t-butyl), amino (such as dimethylamino) or an ester substituent. In some embodiments, all three R groups may be the same substituent. In some embodiments, two of the R groups may be the same substituent.

The embodiment of FIG. 1A presents an example of a non-swing type purifier. Rather than swinging the potential of an electrode during CO₂ purification, it employs a cathode that maintains a cathodic potential and an anode that maintains an anodic potential. Purified CO₂ may be continuously generated, rather than only during periods when previously charged CO₂-absorbing electroactive moieties are exposed to anodic conditions.

In operation, CO₂ purifier 101 receives impure CO₂ stream 103 via an inlet such as a conduit (not shown). In various embodiments, CO₂ stream 103 enters cathode compartment 111 where it contacts the medium (with CO₂-absorbing electroactive moieties relatively free of absorbed CO₂) in proximity to cathode 105. The contact may take any of various forms such as by bubbling, passage through a gas diffusion layer, countercurrent flow, etc. During contact between the CO₂ from stream 103 and the medium in a cathodic environment, the CO₂-absorbing electroactive moieties are converted to form 115. Unreacted CO₂ and other components of impure stream CO₂ 103 may exit purifier 101 as a waste gas stream 121 via a conduit or other outlet.

After taking up CO₂ from stream 103, the component having CO₂-absorbing electroactive moieties flows or is otherwise transported between anode chamber 113 and cathode chamber 111. The transport may be driven by any of various mechanisms such as by a pump and associated conduit(s). The medium may be in a flowable state such as in a liquid state (e.g., as a liquid, a melt, or a compound dissolved in a solvent).

Upon entry into cathode chamber 111, the component may be substantially or relatively free of CO₂ (e.g., form 117). But while contacting the CO₂ in the input stream under cathodic conditions, the component absorbs or otherwise reacts with CO₂ to form a medium in a form such as carbonate-containing medium 115.

Component 115 containing absorbed CO₂ is transported from cathode chamber 111 to anode chamber 113 via any of various mechanisms such as by a pump and associated conduit(s).

Once in anode chamber 113, component 115 is exposed to anodic conditions, under which it releases CO₂ and reverts to form 117. The released CO₂ is purified in comparison to the impure CO₂ stream 103. The released CO₂ forms a purified CO₂ stream 119 that may exit the purifier via an outlet such as a conduit (not shown).

As explained, a CO₂ purifier may contain electroactive CO₂-absorbing moieties that capture CO₂ at a first potential and release it at a second potential. In various embodiments, the first potential is more cathodic than the second potential.

While FIG. 1A depicts systems that use media having quinone moieties, the concepts depicted in these figures extend to embodiments that employ non-quinone CO₂-absorbing electroactive moieties such as thiolates, di-pyridinium species, and the like. In some examples, the compound comprising one or more electroactive CO₂-absorbing moieties is a polymer or ionic liquid comprising quinone moieties.

In certain embodiments, one or more electroactive CO₂-absorbing moieties are provided on a chemical compound. In certain embodiments, the one or more electroactive CO₂-absorbing moieties are provided on a polymer or ionic liquid. In some cases, the one or more CO₂-absorbing moieties are pendant to a backbone of the polymer. In some cases, the one or more CO₂-absorbing moieties comprise quinone moieties.

The CO₂-absorbing moieties may be part of a transportable medium that moves between electrodes (e.g., between a cathode chamber and an anode chamber). Such embodiments may employ CO₂-absorbing moieties on a polymer or ionic liquid. In certain embodiments, the polymer is a melt or is dissolved in a solution.

Examples of polymer structures having CO₂-absorbing moieties suitable for use with a purifier as described here are presented in U.S. Provisional Patent Application No. 63/366,901, filed Jun. 23, 2022, and incorporated herein by reference in its entirety.

In some aspects of this disclosure, a CO₂ purifier relies on ions dissolved in a medium that flows within the CO₂ purifier. The ions may carry CO₂ within the purifier. Examples of such ions include carbonate ions and bicarbonate ions. They may flow in aqueous solutions as salts.

In certain embodiments, a CO₂ purifier selectively captures CO₂ from an impure CO₂ stream by converting the CO₂ to carbonate and/or bicarbonate ions. The purifier may then release the captured CO₂ by converting the carbonate and/or bicarbonate ions to CO₂ at different locations than the impure CO₂ inlet.

In some implementations, the impure CO₂ stream is contacted with a basic solution (e.g., an aqueous solution) that converts the CO₂ to carbonate or bicarbonate ions. Subsequently, the carbonate and/or bicarbonate ions are transported to an acid solution (e.g., an aqueous solution) that coverts the ions to CO₂ and water. In some embodiments, the carbonate and/or bicarbonate ions pass from a basic environment to an acidic environment under the influence of an electrical field created between electrodes in the CO₂ purifier. In some implementations, the carbonate and/or bicarbonate ions pass through an ion exchange membrane that separates the basic and acidic environments.

In certain embodiments, a CO₂ purifier comprises a plurality of parallel liquid flow paths between two electrodes. The plurality of parallel liquid flow paths may comprise: (i) a carbonate donating flow path configured to flow a first solution containing carbonate and/or bicarbonate ions and bounded on a first side by an anion exchange membrane, and (ii) a carbonate receiving flow path arranged adjacent to said carbonate donating flow path and configured to flow a second solution that is more acidic than the first solution. The carbonate receiving flow path is bounded by the anion exchange membrane that allows the carbonate and/or bicarbonate ions to pass from the carbonate donating flow path to the carbonate receiving flow path.

In some embodiments, the carbonate donating flow path is bounded on a second side by a bipolar membrane. In some embodiments, the carbonate receiving flow path is bounded by a bipolar membrane, located opposite the anion exchange membrane. A bipolar membrane is a two-layer structure comprises an anion conducting membrane and a cation conducting membrane.

The plurality of parallel liquid flow paths may contain multiple pairs of alternating carbonate donating flow paths and carbonate receiving flow paths. For example, the plurality of parallel liquid flow paths additionally comprises: (i) a second carbonate donating flow path configured to flow the first solution; and (ii) a second carbonate receiving flow path arranged adjacent to the second carbonate donating flow path and configured to flow the second solution.

In some cases, the CO₂ purifier includes elements that allow recycling of the first solution and/or the second solution. For example, the CO₂ purifier may include a first solution tank configured to supply the first solution to the carbonate donating flow path and a recycle path configured to recycle the first solution from the carbonate donating flow path to the first solution tank. And, in some embodiments, the CO₂ purifier include a second solution tank configured to supply the second solution to the carbonate receiving flow path and a recycle path configured to recycle the second solution from the carbonate receiving flow path to the second tank.

In certain embodiments, the CO₂ purifier comprises (i) a first electrode that is a bipolar plate that separates the CO₂ purifier from a CO₂ electrolyzer and (ii) a second electrode that is an outer electrode not physically contact the CO₂ electrolyzer.

FIG. 1B schematically illustrates a CO₂ purifier 150 that employs parallel streams of carbonate donating liquid and carbonate receiving liquid separated by ion exchange membranes. The input for system 150 is dilute or impure CO₂ stream 151 such as air.

The system 150 comprises an electrodialysis stack 159 composed of “cells” or flow paths. The cells are defined by membranes of different ionic conductivity, which membranes alternate in parallel. The cells provide at least two different solution flow paths running between the membranes. The membranes are cation exchange membranes 161, bipolar membranes 165, and anion exchange membranes 163; and the two different solution flow paths include carbonate receiving flow paths 179 for acidic solutions and carbonate donating flow paths 181 for basic solutions. Some of the basic solution flows through the carbonate donating flow paths 181, each separated from an acidic carbonate receiving path 179 by an anion exchange membrane 163. Some other portion of the basic solution flows through a carbonate flow path 182 disposed between a bipolar membrane 165 and a cation exchange membrane 161. Flow path 182 accepts positive ions moving away from a positive electrode under the influence of the electric field within electrodialysis stack 159. The acidic solution runs through the carbonate receiving flow paths 179 disposed adjacent to carbonate donating flow paths 181 but separated therefrom by anion exchange membranes 163.

Stack 159 includes at least one pair of cells comprising a carbonate donating cell and a carbonate receiving cell. However, a stack may contain numerous pairs of cells in some embodiments. System 150 includes two pairs of alternating flow paths 181 and 179.

The stack 159 also includes cation exchange membranes (CEMs) 161 at both ends of the series of parallel flow paths (cells); one on the cathode-facing side and one on the anode-facing side. The cation exchange membranes 161 are parallel to each electrode, and flow paths 183 run between the CEM and the electrode at each end of the stack. Electrode solution runs through flow paths 183. In some embodiments, the electrode solution in paths 183 comprises about 0.1 to about 5 M KOH.

The electrode solution may be pumped from one electrode solution reservoir (not shown) into electrodialysis stack 159 at both the cathode 157 and anode 155 ends, flowing over the electrodes at each end, and then flowing back out of stack 159 and back into the electrode solution reservoir.

Dilute carbon dioxide 151 is fed through an inlet and bubbled into a first solution tank 167. First solution tank 167 holds a basic solution including carbonate (CO₃²⁻) and/or bicarbonate ions (HCO₃⁻), and a caustic substance and may optionally be agitated, heated, or pressurized. In some embodiments, the pH of the basic solution is from about 8 to about 14. The carbon dioxide from feed 151 reacts with hydroxide ions (OH) present in the basic solution to produce the CO₃²⁻ and/or HCO₃⁻. Caustic substances such as potassium hydroxide (KOH) or sodium hydroxide (NaOH) may be utilized to form the basic aqueous solution. In some embodiments, first solution tank 167 holds a solution of Na HCO₃, KHCO₃, Na₂CO₃, K₂CO₃, NaOH, KOH, or any combination thereof, optionally in a concentration range of from about 0.1M to about 5M. The pH of the solution may be monitored, and basic salt solution may be replenished as needed.

Purifier system 150 also has a second solution tank 173. Second solution tank 173 holds an acidic solution including at least one acid that may be agitated, heated, or pressurized. Suitable acids include sodium or potassium phosphates. In some embodiments, the acid may be a mixture of potassium dihydrogen phosphate (KH₂PO₄) and phosphoric acid (H₃PO₄), optionally in a concentration range of from about 0.1M to about 5M.

The acidic solution from the second solution tank 173 is conveyed to the carbonate receiving flow paths 179 via conduit 175. Recycle flow path 177 returns acidic solution from the stack 159 to the second solution tank 173.

The basic solution is transported via conduit 169 to carbonate donating flow paths 181. Recycle flow path 171 returns solution from the stack 159 to the first solution tank 167.

Purifier system 150 operates by driving carbonate/bicarbonate ions from basic solution in flow channels 181 to acidic solution in flow channels 179. The ions are driven by application of voltage across the alternating stack of ion-selective anion-exchange membranes and bipolar membranes and thereby move carbon dioxide from impure carbon dioxide 151 into an acidic solution as HCO₃⁻ ions or CO₃⁻² ions. The movement of ions across the various membranes and into the various flow paths is indicated in FIG. 1B. The acidic solution converts the transported CO₃⁻² or HCO₃⁻; into a resultant CO₂ gas 153 which is purer and/or more concentrated than carbon dioxide of input stream 151.

CO₂ Sources for the CO₂ Purifier

A carbon dioxide purifier such as one integrated with a carbon dioxide electrolyzer, as described herein, may receive impure CO₂ that originates from any of various sources. Examples include air or other ambient gas, combustion output gases, and factory output such as output from a cement plant or a steelmaking plant. Combustion gases may be produced by, for example, a turbine, an engine, or other device that may be provided in stationary structure (e.g., a powerplant) or in a mobile structure (e.g., a transportation vehicle). In certain embodiments, impure CO₂ is from tailpipe exhaust. Typically, though not necessarily, the CO₂ provided to purifier is in gaseous form.

An integrated CO₂ purifier and CO₂ electrolyzer system may include a connection between a CO₂ containing output of a device such as an energy conversion device (e.g., a combustion turbine or fuel cell) and an input of the CO₂ purifier. The CO₂ containing output of such device may be connected to a gas compression system and/or other system, which then connects to an input of a CO₂ purifier of the disclosure. Multiple CO₂ generating devices and/or gas compression systems may be connected to a CO₂ purifier. The carbon dioxide containing output may be stored in a storage vessel.

A source of CO₂ may be connected directly to an input of a CO₂ purifier. In some embodiments, the carbon dioxide serves as the input to the cathode of an electrochemical CO₂ purifier via, e.g., a cathode flow field and/or a gas diffusion layer, etc. In some embodiments, the CO₂ is provided to a purifier after being compressed by, e.g., a gas compression system. In some embodiments, CO₂ provided to a CO₂ purifier may be recycled from a chemical reaction of a carbon-containing product of the CO₂ electrolyzer.

Impure CO₂ provided as input to a carbon dioxide purifier may have a range of concentrations. In certain embodiments, impure carbon dioxide provided to a carbon dioxide purifier has a concentration of about 20% or less, or about 0.01% to about 70% by volume or molar. In certain embodiments, carbon dioxide provided to a carbon dioxide purifier has a concentration of about 0.04% to about 70% by volume or molar. The CO₂ provided as input to a CO₂ purifier integrated with a CO₂ electrolyzer may be or may comprise air.

### Output of CO₂ Purifier

In certain embodiments, purified carbon dioxide output from a purifier and provided to a carbon dioxide electrolyzer has a concentration of at least about 20% by volume or mole, or at least about 40% by volume or mole, or at least about 75% by volume or mole, or at least about 90% by volume or mole. In certain embodiments, carbon dioxide provided to a carbon dioxide reduction reactor has a concentration of about 40 to 60% by volume or mole.

Electrochemical Systems employing a CO₂ Purifier and a CO₂ Electrolyzer

As indicated, some systems integrate a CO₂ purifier and a CO₂ electrolyzer in a single electrochemical cell having a bipolar plate separating the purifier and electrolyzer. The CO₂ purifier may take various forms, some of which are described herein. In general, the CO₂ purifier is a unit that utilizes at least two electrodes. A first one of the electrodes may be connected to an external circuit and a second one may be the bipolar plate that separates the purifier and electrolyzer. More specifically, the second electrode may be a surface of the bipolar plate that is adjacent to the CO₂ purifier (e.g., the surface facing the first electrode) or it may be a part of the bipolar plate. The CO₂ electrolyzer also has two electrodes, one connected to the external circuit and the other an adjacent surface or part of the bipolar plate. The electrode of the CO₂ electrolyzer that is connected to the external circuit has a polarity that is opposite that of the electrode of the CO₂ purifier that is also connected to the external circuit.

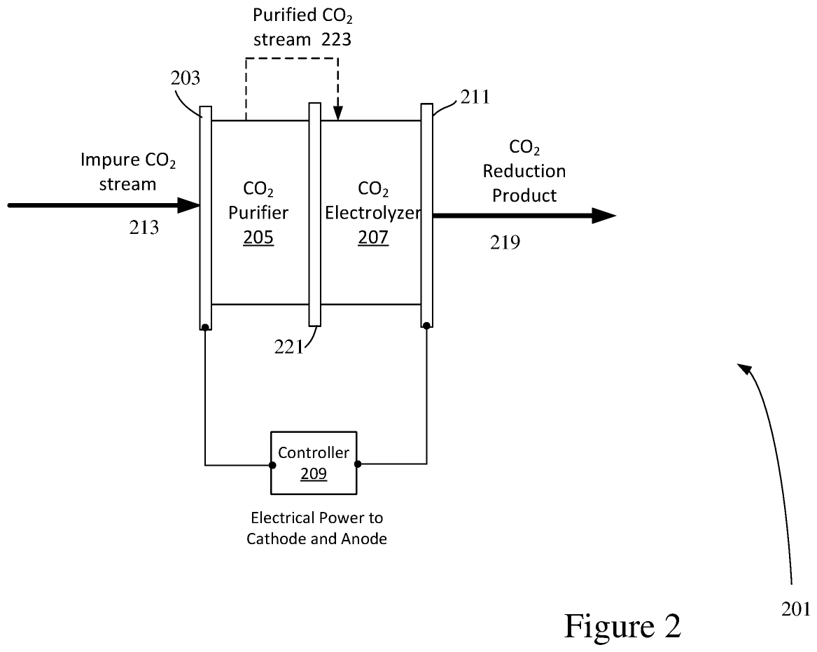

FIG. 2 schematically illustrates, at a general level, components of an integrated CO₂ purifier and CO₂ electrolyzer in accordance with certain embodiments. The integrated system is depicted by reference number 201. The integrated system 201 is bounded by two outer electrodes 203 and 211. Internally, integrated system 201 includes a CO₂ purifier 205 and a CO₂ electrolyzer 207 separated by a bipolar conductive plate 221.

As depicted, CO₂ purifier 205 is bounded by outer electrode 203 and bipolar plate 221. In operation, these two elements serve as electrodes that maintain a potential difference across the purifier 205. Similarly, CO₂ electrolyzer 207 is bounded by outer electrode 211 and bipolar plate 221. During operation, a potential difference is maintained within CO₂ electrolyzer 207 between electrodes 211 and 221.

During operation, a controller and/or power source 209 applies an electrical potential difference between outer electrodes 203 and 211. Bipolar plate 221 which serves as an electrode for both purifier 205 and electrolyzer 207 maintains a potential intermediate between that of electrode 203 and electrode 211. Note that bipolar plate 221 is not connected to controller or power source 209.

While exposed to the potential difference applied by controller and/or power source 209, impure CO₂ flows via a stream 213 into purifier 205. Acting under the influence of the potential difference between electrodes 203 and 221, CO₂ purifier 205 produces a purified carbon dioxide stream 223. Integrated system 201 is configured to deliver the purified carbon dioxide stream 223 to a cathode of CO₂ electrolyzer 207. The CO₂ in stream 223 is reduced at the cathode of electrolyzer 207 to produce one or more carbon dioxide reduction products that exit system 201 via an output stream 219.

In some embodiments, the positive terminal of controller 209 is attached to CO₂ purifier 205 via electrode 203, so that electrode 203 serves as the anode and bipolar plate 221 serves as the cathode of purifier 205. In such embodiments, the negative terminal of controller 209 is attached to CO₂ electrolyzer 207 via electrode 211, so that electrode 211 serves as the cathode and bipolar plate 221 serves as the anode of electrolyzer 207.

In other embodiments, the positive terminal of controller 209 is attached to CO₂ electrolyzer 207 via electrode 211, so that electrode 211 serves as the anode and bipolar plate 221 serves as the cathode of electrolyzer 207. In such embodiments, the negative terminal of controller 209 is attached to CO₂ purifier 205 via electrode 203, so that electrode 203 serves as the cathode and bipolar plate 221 serves as the anode of purifier 205.

In certain embodiments, an electrically integrated CO₂ purifier and electrolyzer system such as depicted in FIG. 2 may include more than one bipolar plate, which define a stack having additional CO₂ electrolyzer and/or purifier modules. An integrated CO₂ purifier and electrolyzer may incorporate a stack of two or more units within the CO₂ purifier and/or the CO₂ electrolyzer modules. Such stacks are not depicted in FIG. 2.

As explained, in some embodiments, a CO₂ purifier employs a polymer, ionic liquid, or other medium comprising CO₂-binding electroactive moieties such as quinone moieties. These moieties selectively react with carbon dioxide to form, e.g., carbonate moieties when exposed to an electrochemical reducing environment and selectively release carbon dioxide when exposed to an electrochemical oxidizing environment. Because these moieties typically do not bind components of an inlet stream other than CO_{2,} the CO₂ released from the purifier has increased purity compared with the CO₂ in the inlet stream.

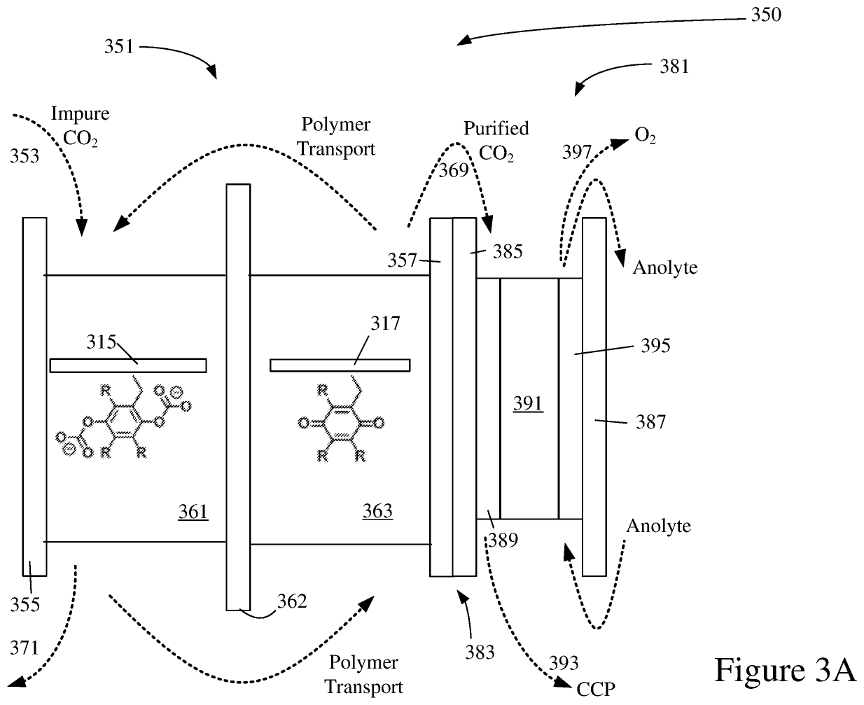

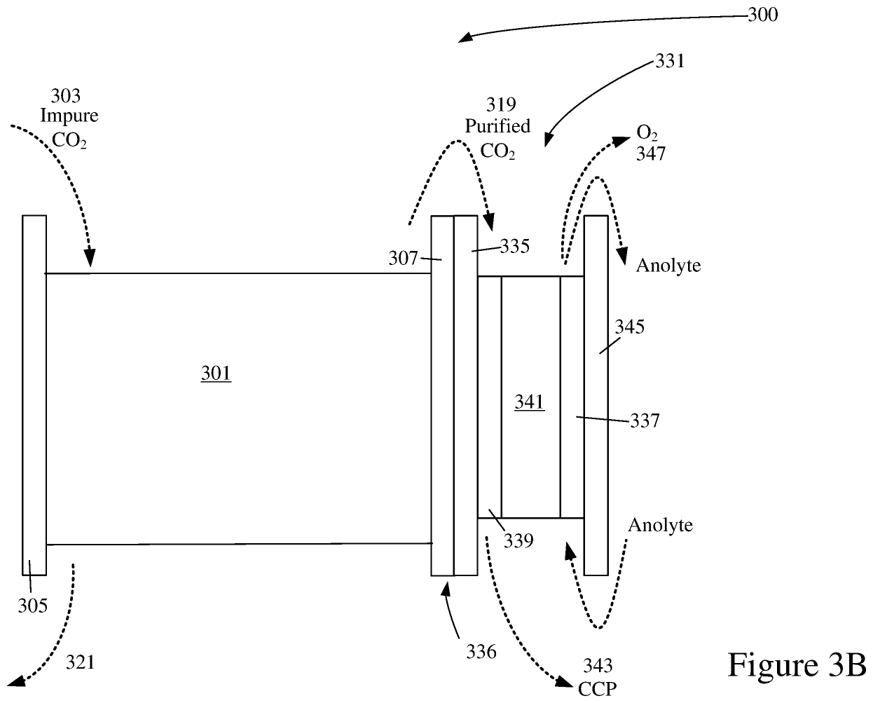

FIG. 3A schematically illustrates an integrated system 350 that includes a CO₂ purifier 351 electrically integrated with a CO₂ electrolyzer 381. The electrical integration is provided via a bipolar plate 383 that provides an anodic surface 357 for CO₂ purifier 351 and a cathodic surface 385 for CO₂ electrolyzer 381. The integrated system comprising CO₂ purifier 351 and CO₂ electrolyzer 381 of system 350 has an outer cathode 355 and an outer anode 387. While outer cathode 355 and outer anode may be electrically connected as terminals to an external circuit, bipolar plate 383 may not be.

CO₂ purifier 351 functions similarly to purifier 101 depicted in FIG. 1A. A polymer, ionic liquid, or other component comprising electroactive CO₂-absorbing moieties flows or is otherwise transported between an anode chamber 363 and a cathode chamber 361, which are separated by an ionically conductive separator 362. In certain embodiments, each R substituent on the quinone moiety depicted may independently represent a cyano, halo, aliphatic (such as t-butyl), amino (such as dimethylamino) or an ester substituent. In some embodiments, all three R groups may be the same substituent. In some embodiments, two of the R groups may be the same substituent.

In cathode chamber 361, under cathodic conditions, the component in form 315 reacts with CO₂ from stream 353 to produce the modified component in form 317 (with CO₂ reacted to form carbonate moieties). A waste gas stream 371—depleted of CO₂ by reaction with the component in form 315—may be eliminated from cathode chamber 361.

Component 317 is transported to anode chamber 363 where it is exposed to anodic conditions (due to the presence of anode surface 357) and reacts to release CO₂ a purified CO₂ stream 369.

On the electrolyzer side (381), purified CO₂ stream 369 enters a flow field, gas diffusion membrane, or the like (389) to allow it to contact a cathode of an MEA 391 and produce a carbon containing product (CCP) 393, which exits system 351 via an electrolyzer cathode outlet such as a conduit (not shown).

Electrolyzer 381 also includes an anode contact element 395 (e.g., a solid porous structure) configured to receive a reactant such as water, an aqueous solution, or other anolyte that and contact it with an anode of MEA 391 where it is oxidized. Unreacted anolyte and an anolyte oxidation product (e.g., O₂) 397 exit electrolyzer 381 via one or more outlets.

FIG. 3B schematically illustrates an integrated system 300 that includes a parallel flow CO₂ purifier 301 electrically integrated with a CO₂ electrolyzer 331. System 300 includes a bipolar plate 336 that serves as an electrode for both purifier 301 and electrolyzer 331. In certain embodiments, purifier 301 is implemented as a parallel flow electrodialysis unit such as unit 150 of FIG. 1B.

System 300 is configured to receive impure carbon dioxide 303 direct it into purifier, electrodialysis unit 301. CO₂ purifier 301 produces purified CO₂ 319 and a CO₂-depleted outlet stream 321. The purified carbon dioxide 319 from electrodialysis unit 301 is fed into CO₂ electrolyzer 331, which converts purified carbon dioxide 319 into carbon containing products 343 at a cathode 339. Electrolyzer 331 also converts water to oxygen 347 at an anode 337.

CO₂ purifier 301 may purify carbon dioxide by utilizing ion exchange membranes and an electrical potential difference between a cathode 305 and an anode 307, which is part of (or a face of) bipolar plate 336. The potential difference may drive ionic species (notably carbonate and/or bicarbonate ions) from a basic aqueous solution across anion exchange membranes to an acidic aqueous solution. Such mechanism is illustrated above with reference FIG. 1B and associated description.

In certain embodiments, impure CO₂ 303 is provided to a reservoir (not shown) before it is provided to CO₂ purifier 301. This may be appropriate when impure CO₂ is produced at times or on a schedule that differs from the operating regime of system 300. As indicated, impure CO₂ may be contacted with a basic pH solution outside the parallel flow paths of an electrodialysis unit. As an example, the impure CO₂ may be delivered to a basic solution tank (not shown), optionally from an impure CO₂ storage reservoir. Upon contact of the basic solution with the impure CO₂, the solution is optionally agitated. Impure CO₂ 303 reacts with the basic salt solution to form carbonate or bicarbonate anions. The carbonate or bicarbonate anions are fed into CO₂ purifier 301 via an appropriate flow path (not shown). In electrodialysis units employing multiple carbonate/bicarbonate donating flow paths, the basic solution may be divided into multiple parallel streams (optionally from a basic solution tank) to the multiple flow paths.

As indicated, when implemented as an electrodialysis unit, CO₂ purifier 301 includes anode 307, cathode 305, a plurality of ion exchange membranes (not shown, which may include anion exchange membranes along with bipolar membranes and/or cation exchange membranes) and flow paths (not shown) bounded by such membranes. Some of the flow paths transport the basic solution containing carbonate and/or bicarbonate ions and other flow paths transport acidic solution. In certain embodiments, the basic solution is recycled to a basic solution tank. Make up basic solution may be provided in such tank or elsewhere in a recycle path.

In certain embodiments, system 300 includes an acid solution tank (not shown) that contains an acidic solution. The acidic solution is provided to carbonate/bicarbonate receiving flow paths (not shown) in the CO₂ purifier 301 (implemented as an electrodialysis unit) from, e.g., the acid solution tank via an appropriate flow path (not shown). In electrodialysis units employing multiple carbonate/bicarbonate receiving flow paths, the acid solution may be divided into multiple parallel streams (optionally from an acid solution tank) to the multiple receiving flow paths. After flowing through these carbonate/bicarbonate receiving paths, the acidic solution may be recycled, optionally back to an acid solution tank. Make up acid solution may be provided in such tank or elsewhere in a recycle path.

As indicated, carbonate and/or bicarbonate ions in one or more basic solution flow paths pass across anion conducting membranes where they are received by acid solution flowing in one or more parallel flow paths. In the acid environment, carbonate and bicarbonate ions are converted to free CO_{2.} In embodiments in which acid solution is recycled to an acid solution tank, the acid brings along free CO_{2.} The purified, free CO₂ 319 may be recovered from a gas headspace of an acid solution tank.

In certain embodiments, purified CO₂ 319 is transported from the acid solution tank via a flow path into a purified CO₂ reservoir. In some embodiments, system 300 is configured to provide purified CO₂ 319 directly to CO₂ electrolyzer 331, without first storing CO₂ 319 in a reservoir.

The CO₂ electrolyzer 331 comprises an anode current collector 345, a cathode current collector 335, and a membrane electrode assembly (MEA) comprising anode 337, a separator membrane 247, and cathode 339. Cathode current collector 335 is part of bipolar plate 336. In certain embodiments, bipolar plate 336 comprises only cathode current collector 335 (for electrolyzer 331) and anode 307 (for purifier 301). In some implementations, bipolar plate 336 is a monolithic, electronically conductive (but not ionically conductive) structure.

Purified CO₂ 319 is fed into electrolyzer 331 where it is electrochemically reduced at cathode 339 and converted into carbon containing products 343. Water (not shown) is fed to anode 337, where it is oxidized to produce oxygen 347.

As indicated, integrated systems such as those depicted in FIGS. 2, 3A and 3B employ a bipolar plate. In certain embodiments, a bipolar plate comprises a single electrically conductive structure configured to serve as a counter electrode to both the outer electrode of the CO₂ purifier and the outer electrode of the CO₂ electrolyzer. For example, the bipolar plate may serve as the anode of the CO₂ purifier and the cathode of the CO₂ electrolyzer or vice versa. The bipolar plate will collect electrical current generated at the output terminals. The bipolar plate may be constructed of material that can withstand the electrochemical environments of both the purifier and the electrolyzer. In some embodiments, the bipolar plate is a monolithic structure having a single composition. In some embodiments, the bipolar plate a multipartite structure having different compositions at different locations. For example, the plate may be a laminate of different sub-plates; e.g., a first subplate that serves as an anode for the CO₂ purifier and a second subplate that serves as a cathode for the CO₂ electrolyzer.

The bipolar plate may be made of conductive material such as a metal, alloy, graphite, metal carbide, or the like. Some bipolar plates may integrate with or incorporate a flow field. In such embodiments, the flow field, which may be incorporated in the bipolar plate, may have some grooves and/or channels to allow gas or liquid to pass through. The surface of such bipolar plate may be pretreatment with surface polish, and plasma treatment for a smooth and robust finished surface.

In addition to the CO₂ purifier and electrolyzer, an integrated system such as those depicted in FIG. 3A and/or 3B, may include components for capturing, conveying, and/or storing impure CO₂ that is to be provided to the purifier. Similarly, any such components may be provided for purified CO₂ produced by the CO₂ purifier. Alternatively, or in addition, an integrated system may include components for capturing, conveying, and/or storing one or more outputs of a CO₂ electrolyzer.

In some embodiments, purified CO₂ produced by a CO₂ purifier is provided directly from an output of the purifier to an input of a CO₂ electrolyzer. In some embodiments, purified CO₂ produced by a CO₂ purifier is first provided to pressure adjusting component, a temperature adjusting component, and/or or a humidifier before it is provided as an input of a CO₂ electrolyzer. In some embodiments, purified CO₂ produced by a CO₂ purifier is first provided to storage vessel before it is provided as an input of a CO₂ electrolyzer. A “storage device” is a container or containment region that can hold a material such as purified CO₂, or mixture containing purified CO₂ and one or more other components. In some embodiments, a storage device is a vessel configured to hold a gas or liquid at a pressure higher than ambient or local pressure. A storage device may contain a metal or ceramic wall or chamber. In some embodiments, a storage device includes a natural or geological structure such as a salt dome or a depleted oil or gas field.

In some embodiments, an integrated system includes one or more components for using or converting CO₂ reduction products from the CO₂ electrolyzer. Such components may be employed downstream of the electrolyzer. Examples of such components are presented in PCT Application No. PCT/US2021/044378, filed Aug. 3, 2021, which is incorporated herein by reference in its entirety.

### CO₂ Electrolyzer Outputs

An integrated CO₂ purifier and CO₂ electrolyzer system may output one or more chemically reduced CO₂ products from the electrolyzer's cathode. Such outputs may include one or more carbon-containing products such as carbon monoxide, one or more hydrocarbons (e.g., methane, ethene, and/or ethane), one or more alcohols (e.g., methanol, ethanol, n-propanol, and/or ethylene glycol), one or more aldehydes (e.g., glycolaldehyde, acetaldehyde, glyoxal, and/or propionaldehyde), one or more ketones (e.g., acetone and/or hydroxyacetone), one or more carboxylic acids (e.g., formic acid and/or acetic acid), and any combination thereof. The electrolyzer's cathode may also produce H₂. A CO₂ purifier and electrolyzer integrated system may output one or more chemically oxidized H₂O products such as oxygen. Additional outputs of an electrolyzer may include unreacted CO₂ and/or unreacted H₂O.

A CO₂ electrolyzer of the disclosure may be directly connected (e.g., via the cathode flow field and/or gas diffusion layer) to a downstream system. In some embodiments, the downstream system is or comprises a purification system; a gas compression system; or both a purification system and a gas compression system, in either order; which then optionally connect to an input of a downstream reactor and/or to one or more storage devices. Multiple purification systems and/or gas compression systems may be employed. In various embodiments, a carbon-containing product, hydrogen, and/or oxygen produced by a carbon oxide electrolyzer is provided to a storage vessel for the carbon-containing product and/or a storage vessel for the oxygen.

An integrated CO₂ electrolyzer and CO₂ purifier a described herein may be configured, designed, and/or controlled in a manner that allows the electrolyzer to produce one or more CO₂ electrolysis products in a quantity, concentration, and/or ratio suitable for any of various downstream processes such as producing valuable carbon-containing products such as plastics and/or producing fuels such as syngas or naphtha. In certain embodiments, a CO₂ electrolyzer is configured to produce a hydrocarbon such as methane or ethene which may be combusted and/or utilized by fuel-cell to generate electrical energy.

Different CO₂ electrolyzers (e.g., including different layer stacks, catalysts and/or catalyst layers, PEMs, flow fields, gas diffusion layers, cell compression configurations, and/or any other suitable aspects, etc.) can be used to produce different reduction products; however, different reduction products can additionally or alternatively be produced by adjusting the operation parameters, and/or be otherwise achieved.

### CO₂ Electrolyzer

### Carbon Oxide Electrolyzer Design and Operating Conditions

A carbon oxide electrolyzer's design and operating conditions can be tuned for particular applications. Often this involves designing or operating the electrolyzer in a manner that produces a cathode output having specified compositions. In some implementations, one or more general principles may be applied to operate an electrolyzer in a way that produces a required output stream composition.

High CO₂ Reduction Product (Particularly CO) to CO₂ Ratio Operating Parameter Regime

In certain embodiments, an electrolyzer is configured to produce, and when operating actually produce, an output stream having a CO:CO₂ molar ratio of at least about 1:1 or at least about 1:2 or at least about 1:3. A high CO output stream may alternatively be characterized as having a CO concentration of at least about 25 mole %, or at least about 33 mole %, or at least about 50 mole %.

In certain embodiments, this high carbon monoxide output concentration is obtained by operating a carbon dioxide electrolyzer in a manner that produces any one of or any combination of the following operating conditions:
a current density of at least about 300 mA/cm₂, at the cathode,
a CO₂ stoichiometric flow rate (as described elsewhere herein) of at most about 4, or at most about 2.5, or at most about 1.5,
a temperature of at most about 80° C. or at most about 65° C.,
a pressure range of about 75 to 400 psig,
an anode water composition of about 0.1 to 50 mM bicarbonate salt, and
an anode water pH of at least about 1.

In certain embodiments, the electrolyzer may be built to favor high CO:CO₂ molar ratios or concentrations, as defined here, by using a carbon dioxide electrolyzer having any one of or any combination of the following properties:
relatively small nanoparticle cathode catalysts (e.g., having largest dimensions of, on average, about 0.1-15 nm),
gold as the cathode catalyst material,
a cathode catalyst layer thickness of about 5-20 μm,
a cathode gas diffusion layer (GDL) with a microporous layer (MPL),
a cathode GDL with PTFE present at about 1-20 wt %, or about 1-10 wt %, or about 1-5 wt %,
a GDL that has a thickness of at least about 200 μm,
a bipolar MEA having an anion-exchange cathode buffer layer having a thickness of at least about 5 μm, and
a cathode flow field having parallel and/or serpentine flow paths.

High Reduction Product to Hydrogen Product Stream Operating Parameter Regime

In certain embodiments, a carbon dioxide electrolyzer is configured to produce, and when operating actually produces, an output stream having CO:H₂ in a molar ratio of at least about 2:1.

In certain embodiments, such product rich output concentration is obtained by operating a carbon dioxide electrolyzer in a manner that produces any one of or any combination of the following operating conditions:
a current density at the cathode of at least about 300 mA/cm²,
a CO₂ mass transfer stoichiometric flow rate to the cathode of at least about 1.5, or at least about 2.5, or at least about 4,
a temperature of at most about 80° C.,
a pressure in the range of about 75 to 400 psig,
an anode water composition of about 0.1 mM to 50 mM bicarbonate salt, and an anode water pH of greater than about 1.

In certain embodiments, the electrolyzer may be built to favor product-rich molar ratios or concentrations, as defined here, by using a carbon dioxide electrolyzer having any one of or any combination of the following properties:
relatively small nanoparticle catalysts (e.g., having largest dimensions of, on average, about 0.1-15 nm),
gold as the cathode catalyst material,
a cathode catalyst layer thickness of about 5-20 μm,
a cathode gas diffusion layer with a microporous layer (MPL),
a cathode GDL with PTFE present at about 1-20 wt %, or about 1-10 wt %, or about 1-5 wt %,
a cathode GDL that has a thickness of at least about 200 μm, and
a bipolar MEA having an anion-exchange layer with a thickness of at least about 5 μm.

Hydrocarbon Reduction Product

In energy conversion processes that require methane and/or ethene inputs, a carbon oxide electrolyzer may be designed to favor production of these hydrocarbons. In some embodiments, the electrolyzer cathode employs a transition metal such as copper as a reduction catalyst. See for example PCT Patent Application Publication No. 2020/146402, published Jul. 16, 2020, and titled “SYSTEM AND METHOD FOR METHANE PRODUCTION,” which is incorporated herein by reference in its entirety. Electrolysis systems for producing ethene may be configured to recycle some hydrocarbon product of a carbon oxide electrolyzer back to the cathode and/or provide two more electrolyzers operating in series, with the cathode output of a first electrolyzer feeding the input to a cathode of a second electrolyzer. See for example PCT Patent Application No. PCT/US2021/036475, filed Jun. 8, 2021, and titled “SYSTEM AND METHOD FOR HIGH CONCENTRATION OF MULTIELECTRON PRODUCTS OR CO IN ELECTROLYZER OUTPUT,” which is incorporated herein by reference in its entirety.

### Carbon Oxide Electrolyzer Embodiments

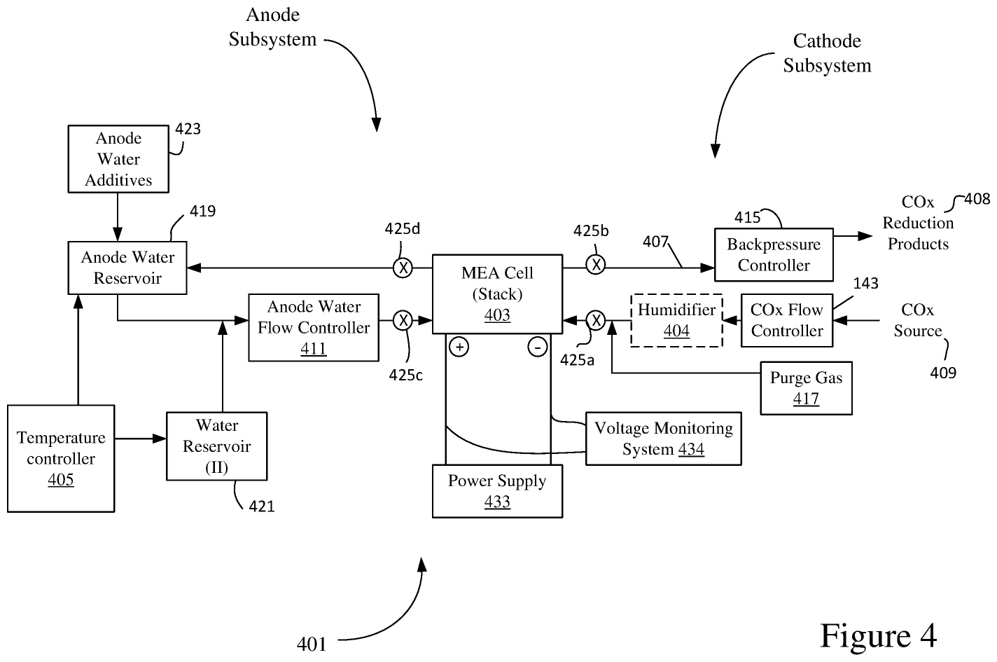

FIG. 4 depicts an example system 401 for a carbon oxide reduction reactor or electrolyzer 403 that may include a cell comprising a MEA (membrane electrode assembly). The reactor may contain multiple cells or MEAs arranged in a stack. System 401 includes an anode subsystem that interfaces with an anode of electrolyzer 403 and a cathode subsystem that interfaces with a cathode of electrolyzer 403. System 401 is an example of a system that may be used with or to implement any of the methods or operating conditions described above.

As depicted, the cathode subsystem includes a carbon oxide source 409 configured to provide a feed stream of carbon oxide to the cathode of electrolyzer 403, which, during operation, may generate an output stream 408 that includes product(s) of a reduction reaction at the cathode. The product stream 408 may also include unreacted carbon oxide and/or hydrogen.

The carbon oxide source 409 is coupled to a carbon oxide flow controller 413 configured to control the volumetric or mass flow rate of carbon oxide to electrolyzer 403. One or more other components may be disposed on a flow path from flow carbon oxide source 409 to the cathode of electrolyzer 403. For example, an optional humidifier 404 may be provided on the path and configured to humidify the carbon oxide feed stream. Humidified carbon oxide may moisten one or more polymer layers of an MEA and thereby avoid drying such layers. Another component that may be disposed on the flow path is a purge gas inlet coupled to a purge gas source 417. In certain embodiments, purge gas source 417 is configured to provide purge gas during periods when current is paused to the cell(s) of electrolyzer 403. In some implementations, flowing a purge gas over an MEA cathode facilitates recovery of catalyst activity and/or selectivity. Examples of purge gases include carbon dioxide, carbon monoxide, hydrogen, nitrogen, argon, helium, oxygen, and mixtures of any two or more of these. Further details of MEA cathode purge processes and systems are described in US Patent Application Publication No. 20220267916, published Aug. 25, 2022, which is incorporated herein by reference in its entirety.

During operation, the output stream from the cathode flows via a conduit 407 that connects to a backpressure controller 415 configured to maintain pressure at the cathode side of the cell within a defined range (e.g., about 50 to 800 psig, depending on the system configuration). The output stream may provide the reaction products 408 to one or more components (not shown) for separation and/or concentration.

In certain embodiments, the cathode subsystem is configured to controllably recycle unreacted carbon oxide from the outlet stream back to the cathode of electrolyzer 403. In some implementations, the output stream is processed to remove reduction product(s) and/or hydrogen before recycling the carbon oxide. Depending upon the MEA configuration and operating parameters, the reduction product(s) may be carbon monoxide, hydrogen, hydrocarbons such as methane and/or ethylene, oxygen-containing organic compounds such as formic acid, acetic acid, and any combinations thereof. In certain embodiments, one or more components, not shown, for removing water from the product stream are disposed downstream form the cathode outlet. Examples of such components include a phase separator configured to remove liquid water from the product gas stream and/or a condenser configured to cool the product stream gas and thereby provide a dry gas to, e.g., a downstream process when needed. In some implementations, recycled carbon oxide may mix with fresh carbon oxide from source 409 upstream of the cathode.

As depicted in FIG. 4, an anode subsystem is configured to provide an anode feed stream to an anode side of the carbon oxide electrolyzer 403. In certain embodiments, the anode subsystem includes an anode water source, not shown, configured to provide fresh anode water to a recirculation loop that includes an anode water reservoir 419 and an anode water flow controller 411. The anode water flow controller 411 is configured to control the flow rate of anode water to or from the anode of electrolyzer 403. In the depicted embodiment, the anode water recirculation loop is coupled to components for adjusting the composition of the anode water. These may include a water reservoir 421 and/or an anode water additives source 423. Water reservoir 421 is configured to supply water having a composition that is different from that in anode water reservoir 419 (and circulating in the anode water recirculation loop). In one example, the water in water reservoir 421 is pure water that can dilute solutes or other components in the circulating anode water. Pure water may be conventional deionized water even ultrapure water having a resistivity of, e.g., at least about 15 MOhm-cm or over 18.0 MOhm-cm. Anode water additives source 423 is configured to supply solutes such as salts and/or other components to the circulating anode water. Examples of anode water salts for various carbon oxide electrolyzer configurations are presented in US Patent Application Publication No. 20200240023, published Jul. 30, 2020, which is incorporated herein by reference in its entirety.

During operation, the anode subsystem may provide water or other reactant to the anode of electrolyzer 403, where it at least partially reacts to produce an oxidation product such as oxygen. The product along with unreacted anode feed material is provided in a reduction reactor outlet stream. Not shown in FIG. 4 is an optional separation component that may be provided on the path of the anode outlet stream and configured to concentrate or separate the oxidation product from the anode product stream.

Other control features may be included in system 401. For example, a temperature controller may be configured to heat and/or cool the carbon oxide electrolyzer 403 at appropriate points during its operation. In the depicted embodiment, a temperature controller 405 is configured to heat and/or cool anode water provided to the anode water recirculation loop. For example, the temperature controller 405 may include or be coupled to a heater and/or cooler that may heat or cool water in anode water reservoir 419 and/or water in reservoir 421. In some embodiments, system 401 includes a temperature controller configured to directly heat and/or cool a component other than an anode water component. Examples of such other components in the cell or stack and the carbon oxide flowing to the cathode.

Depending upon the phase of the electrochemical operation, including whether current is paused to carbon oxide reduction electrolyzer 403, certain components of system 401 may operate to control non-electrical operations. For example, system 401 may be configured to adjust the flow rate of carbon oxide to the cathode and/or the flow rate of anode feed material to the anode of electrolyzer 403. Components that may be controlled for this purpose may include carbon oxide flow controller 413 and anode water controller 411.

In addition, depending upon the phase of the electrochemical operation including whether current is paused, certain components of system 401 may operate to control the composition of the carbon oxide feed stream and/or the anode feed stream. For example, water reservoir 421 and/or anode water additives source 423 may be controlled to adjust the composition of the anode feed stream. In some cases, additives source 423 may be configured to adjust the concentration of one or more solutes such as one or more salts in an aqueous anode feed stream.

In some cases, a temperature controller such controller 405 is configured to adjust the temperature of one or more components of system 401 based on a phase of operation. For example, the temperature of cell 403 may be increased or decreased during break-in, a current pause in normal operation, and/or storage.

In some embodiments, a carbon oxide electrolytic reduction system is configured to facilitate removal of a reduction cell from other system components. This may be useful with the cell needs to be removed for storage, maintenance, refurbishment, etc. In the depicted embodiments, isolation valves 425a and 425b are configured to block fluidic communication of cell 403 to a source of carbon oxide to the cathode and backpressure controller 415, respectively. Additionally, isolation valves 425c and 425d are configured to block fluidic communication of cell 403 to anode water inlet and outlet, respectively.

The carbon oxide reduction electrolyzer 403 may also operate under the control of one or more electrical power sources and associated controllers. See, block 433. Electrical power source and controller 433 may be programmed or otherwise configured to control current supplied to and/or to control voltage applied to the electrodes in reduction electrolyzer 403. The current and/or voltage may be controlled to execute the current schedules and/or current profiles described elsewhere herein. For example, electrical power source and controller 433 may be configured to periodically pause current applied to the anode and/or cathode of reduction electrolyzer 403. Any of the current profiles described herein may be programmed into power source and controller 433.

In certain embodiments, electric power source and controller 433 performs some but not all the operations necessary to implement desired current schedules and/or profiles in the carbon oxide reduction electrolyzer 403. A system operator or other responsible individual may act in conjunction with electrical power source and controller 433 to fully define the schedules and/or profiles of current applied to reduction electrolyzer 403. For example, an operator may institute one or more current pauses outside the set of current pauses programmed into power source and controller 433.

In certain embodiments, the electrical power source and an optional, associated electrical power controller acts in concert with one or more other controllers or control mechanisms associated with other components of system 401. For example, electrical power source and controller 433 may act in concert with controllers for controlling the delivery of carbon oxide to the cathode, the delivery of anode water to the anode, the addition of pure water or additives to the anode water, and any combination of these features. In some implementations, one or more controllers are configured to control or operate in concert to control any combination of the following functions: applying current and/or voltage to reduction cell 403, controlling backpressure (e.g., via backpressure controller 415), supplying purge gas (e.g., using purge gas component 417), delivering carbon oxide (e.g., via carbon oxide flow controller 413), humidifying carbon oxide in a cathode feed stream (e.g., via humidifier 404), flow of anode water to and/or from the anode (e.g., via anode water flow controller 411), and anode water composition (e.g., via anode water source 405, pure water reservoir 421, and/or anode water additives component 423).

In the depicted embodiment, a voltage monitoring system 434 is employed to determine the voltage across an anode and cathode of an MEA cell or across any two electrodes of a cell stack, e.g., determining the voltage across all cells in a multi-cell stack. The voltage determined in this way can be used to control the cell voltage during a current pause, inform the duration of a pause, etc. In certain embodiments, voltage monitoring system 434 is configured to work in concert with power supply 433 to cause reduction cell 403 to remain within a specified voltage range. For example, power supply 433 may be configured to apply current and/or voltage to the electrodes of reduction cell 403 in a way that maintains the cell voltage within a specified range during a current pause. If, for example during a current pause, the cell's open circuit voltage deviates from a defined range (as determined by voltage monitoring system 434), power supply may be configured to apply current or voltage to the electrodes to maintain the cell voltage within the specified range.

An electrolytic carbon oxide reduction system such as that depicted in FIG. 4 may employ control elements or a control system that includes one or more controllers and one or more controllable components such as pumps, sensors, dispensers, valves, and power supplies. Examples of sensors include pressure sensors, temperature sensors, flow sensors, conductivity sensors, voltmeters, ammeters, electrolyte composition sensors including electrochemical instrumentation, chromatography systems, optical sensors such as absorbance measuring tools, and the like. Such sensors may be coupled to inlets and/or outlets of an MEA cell (e.g., in a flow field), in a reservoir for holding anode water, pure water, salt solution, etc., and/or other components of an electrolytic carbon oxide reduction system.

Among the various functions that may be controlled by one or more controllers are: applying current and/or voltage to a carbon oxide reduction cell, controlling backpressure on an outlet from a cathode on such cell, supplying purge gas to a cathode inlet, delivering carbon oxide to the cathode inlet, humidifying carbon oxide in a cathode feed stream, flowing anode water to and/or from the anode, and controller anode feed composition. Any one or more of these functions may have a dedicated controller for controlling its function alone. Any two or more of these functions may share a controller. In some embodiments, a hierarchy of controllers is employed, with at least one master controller providing instructions to two or more component controllers. For example, a system may comprise a master controller configured to provide high level control instructions to (i) a power supply to a carbon oxide reduction cell, (ii) a cathode feed stream flow controller, and (iii) an anode feed stream flow controller. For example, a programmable logic controller (PLC) may be used to control individual components of the system.

In certain embodiments, a control system is configured to control the flow rate of one or more feed streams (e.g., a cathode feed stream such as a carbon oxide flow and an anode feed stream) in concert with a current schedule. For example, the flow of carbon oxide or a purge gas may be turned on, turned off, or otherwise adjusted when current applied to an MEA cell is reduced, increased, or paused.

A controller may include any number of processors and/or memory devices. The controller may contain control logic such software or firmware and/or may execute instructions provided from another source. A controller may be integrated with electronics for controlling operation the electrolytic cell before, during, and after reducing a carbon oxide. The controller may control various components or subparts of one or multiple electrolytic carbon oxide reduction systems. The controller, depending on the processing requirements and/or the type of system, may be programmed to control any of the processes disclosed herein, such as delivery of gases, temperature settings (e.g., heating and/or cooling), pressure settings, power settings (e.g., electrical voltage and/or current delivered to electrodes of an MEA cell), liquid flow rate settings, fluid delivery settings, and dosing of purified water and/or salt solution. These controlled processes may be connected to or interfaced with one or more systems that work in concert with the electrolytic carbon oxide reduction system.

In various embodiments, a controller comprises electronics having various integrated circuits, logic, memory, and/or software that receive instructions, issue instructions, control operations described herein. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a process on one or more components of an electrolytic carbon oxide reduction system. The operational parameters may, in some embodiments, be part of a recipe defined by process engineers to accomplish one or more processing steps during generation of a particular reduction product such as carbon monoxide, hydrocarbons, and/or other organic compounds.

The controller, in some implementations, may be a part of or coupled to a computer that is integrated with, coupled to the system, otherwise networked to the system, or a combination thereof. For example, the controller may utilize instructions stored remotely (e.g., in the “cloud”) and/or execute remotely. The computer may enable remote access to the system to monitor current progress of electrolysis operations, examine a history of past electrolysis operations, examine trends or performance metrics from a plurality of electrolysis operations, to change parameters of current processing, to set processing steps to follow a current processing, or to start a new process. In some examples, a remote computer (e.g., a server) can provide process recipes to a system over a network, which may include a local network or the internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations.

The controller may be distributed, such as by comprising one or more discrete controllers that are networked together and working towards a common purpose, such as applying current to an MEA cell and other process controls described herein. An example of a distributed control system for such purposes includes one or more processors on a system for electrolytically reducing a carbon oxide and one or more processors located remotely (such as at the platform level or as part of a remote computer) that combine to control a process.

Controllers and any of various associated computational elements including processors, memory, instructions, routines, models, or other components are sometimes described or claimed as “configured to” perform a task or tasks. In such contexts, the phrase “configured to” is used to denote structure by indicating that the component includes structure (e.g., stored instructions, circuitry, etc.) that performs a task or tasks during operation. As such, a controller and/or associated component can be said to be configured to perform the task even when the specified component is not necessarily currently operational (e.g., is not on).

Controllers and other components that are “configured to” perform an operation may be implemented as hardware-for example, circuits, memory storing program instructions executable to implement the operation, etc. Additionally, controllers and other components “configured to” perform an operation may be implemented as hardware that is manipulated by software and/or firmware (e.g., an FPGA or a general-purpose processor executing software) to operate in manner that is capable of performing the recited task(s). Additionally, “configured to” can refer to one or more memories or memory elements storing computer executable instructions for performing the recited task(s). Such memory elements may include memory on a computer chip having processing logic.

Non-computation elements such as reactors such electrolyzers, membrane assemblies, layers, and catalyst particles may also be “configured” to perform certain functions. In such contexts, the phrase “configured to” indicate that the referenced structure has one or more features that allow the function to be performed. Examples of such features include physical and/or chemical properties such as dimensions, composition, porosity, etc.

### MEA Embodiments

MEA Overview

In various embodiments, an MEA contains an anode layer, a cathode layer, electrolyte, and optionally one or more other layers. The layers may be solids and/or gels. The layers may include polymers such as ion-conducting polymers.

When in use, the cathode of an MEA promotes electrochemical reduction of COₓ by combining three inputs: COₓ, ions (e.g., hydrogen ions, bicarbonate ions, or hydroxide ions) that chemically react with COₓ, and electrons. The reduction reaction may produce CO, hydrocarbons, and/or hydrogen and oxygen-containing organic compounds such as methanol, ethanol, and acetic acid. When in use, the anode of an MEA promotes an electrochemical oxidation reaction such as electrolysis of water to produce elemental oxygen and protons. The cathode and anode may each contain catalysts to facilitate their respective reactions.

During operation of an MEA, ions move through a polymer-electrolyte, while electrons flow from an anode, through an external circuit, and to a cathode. In some embodiments, liquids and/or gas move through or permeates the MEA layers. This process may be facilitated by pores in the MEA.

The compositions and arrangements of layers in the MEA may promote high yield of a COₓ reduction products. To this end, the MEA may facilitate any one or more of the following conditions: (a) minimal parasitic reduction reactions (non-COₓ reduction reactions) at the cathode; (b) low loss of COₓ reactants to the anode or elsewhere in the MEA; (c) physical integrity of the MEA during the reaction (e.g., the MEA layers remain affixed to one another); (d) prevent COₓ reduction product cross-over; (e) prevent oxidation product (e.g., O₂) cross-over; (f) a suitable environment at the cathode for the reduction reaction; (g) a pathway for desired ions to travel between cathode and anode while blocking undesired ions; and (h) low voltage operation.

COₓ Reduction Considerations

For many applications, an MEA for COₓ reduction requires a lifetime on the order of about 50,000 hours or longer (approximately five years of continuous operation), which is significantly longer than the expected lifespan of a fuel cell for automotive applications; e.g., on the order of 5,000 hours. And for various applications, an MEA for COₓ reduction employs electrodes having a relatively large surface area by comparison to MEAs used for fuel cells in automotive applications. For example, MEAs for COₓ reduction may employ electrodes having surface areas (without considering pores and other nonplanar features) of at least about 500 cm².

COₓ reduction reactions may be implemented in operating environments that facilitate mass transport of particular reactant and product species, as well as to suppress parasitic reactions. Fuel cell and water electrolyzer MEAs often cannot produce such operating environments. For example, such MEAs may promote undesirable parasitic reactions such as gaseous hydrogen evolution at the cathode and/or gaseous CO₂ production at the anode.

In some systems, the rate of a COₓ reduction reaction is limited by the availability of gaseous COₓ reactant at the cathode. By contrast, the rate of water electrolysis is not significantly limited by the availability of reactant: liquid water tends to be easily accessible to the cathode and anode, and electrolyzers can operate close to the highest current density possible.

MEA Configurations

In certain embodiments, an MEA has a cathode layer, an anode layer, and a polymer electrolyte membrane (PEM) between the anode layer and the cathode layer. The polymer electrolyte membrane provides ionic communication between the anode layer and the cathode layer, while preventing electronic communication that would produce a short circuit. The cathode layer includes a reduction catalyst and, optionally, an ion-conducting polymer (sometimes called an ionomer). The cathode layer may also include an electron conductor and/or an additional ion conductor. The anode layer includes an oxidation catalyst and, optionally, an ion-conducting polymer. The anode layer may also include an electron conductor and/or an additional ion conductor. The PEM comprises an ion-conducting polymer. In certain embodiments, the MEA has a cathode buffer layer between the cathode layer and the polymer electrolyte membrane. The cathode buffer comprises an ion-conducting polymer.

The ion-conducting polymers in the PEM, the cathode, the anode, and the cathode buffer layer, if present, may each be different from one another in composition, conductivity, molecular weight, or other property. In some cases, two or more of these polymers are identical or substantially identical. For example, the ion-conducting polymer in the cathode and cathode buffer layer may be identical.

In certain embodiments, the MEA has an anode buffer layer between the anode layer and the polymer electrolyte membrane. The anode buffer layer also comprises an ion-conducting polymer, which may have the same properties as any of the other ion-conducting polymers (e.g., the ion-conducting polymer in the anode). Or the ion-conducting layer of the anode buffer layer may be different from every other ion-conducting layer in the MEA.

In connection with certain MEA designs, there may be three available classes of ion-conducting polymers: anion-conductors, cation-conductors, and mixed cation-and-anion-conductors. In certain embodiments, at least two of the first, second, third, fourth, and fifth ion-conducting polymers are from different classes of ion-conducting polymers.

In certain embodiments, an MEA has a bipolar interface, which means that it has one layer of anion-conducting polymer in contact with a layer of cation-conducting polymer. One example of an MEA with a bipolar interface is an anion-conducting cathode buffer layer adjacent to (and in contact with) a cation-conducting PEM. In certain embodiments, an MEA contains only anion-conducting polymer between the anode and the cathode. Such MEAs are sometimes referred to as “AEM only” MEAs. Such MEAs may contain one or more layers of anion-conducing polymer between the anode and the cathode.

Ion-Conducting Polymers for MEA Layers

The term “ion-conducting polymer” or “ionomer” is used herein to describe a polymer that conducts ions (anions and/or cations) is to say that the material is an ion-conducting material or ionomer. In certain embodiments, an MEA contains one or more ion-conducting polymers having a specific conductivity of about 1 mS/cm or greater for anions and/or cations. The term “anion-conductor” describes an ion-conducting polymer that conducts anions primarily (although there will still be some small amount of cation conduction) and has a transference number for anions of about 0.85 or greater at around 100 micrometers thickness. The terms “cation-conductor” and/or “cation-conducting polymer” describe an ion-conducting polymer that conducts cations primarily (e.g., there can still be an incidental amount of anion conduction) and has a transference number for cations of about 0.85 or greater at about 100 micrometers thickness. For an ion-conducting polymer that is described as conducting both anions and cations (a “cation-and-anion-conductor”), neither the anions nor the cations have a transference number greater than about 0.85 or less than about 0.15 at about 100 micrometers thickness. Examples of ion-conducting polymers of each class are provided in the below Table 1.

Ion-Conducting Polymers

| Class | Description | Common Features | Examples |
|---|---|---|---|
| A. | Greater than | Positively charged | Quaternary ammonium |
| Anion- | approximately 1 | functional groups | or cyclic amine |
| conducting | mS/cm specific | are covalently | moieties on |
| | conductivity for | bound to the | polyphenylene |
| | anions, which have | polymer backbone | backbone; aminated |
| | a transference | | tetramethyl |
| | number greater than | | polyphenylene; |
| | approximately | | poly(ethylene-co- |
| | 0.85 at about 100 | | tetrafluoroethylene)- |
| | micron thickness | | based quaternary |
| | | | ammonium polymer; |
| | | | quaternized polysulfone |
| B. | Greater than | Salt is soluble in | polyethylene oxide; |
| Conducts | approximately 1 | the polymer and | polyethylene glycol; |
| both | mS/cm conductivity | the salt ions can | poly(vinylidene |
| anions and | for ions (including | move through the | fluoride); polyurethane |
| cations | both cations and | polymer material | |
| | anions), which have a | | |
| | transference number | | |
| | between | | |
| | approximately | | |
| | 0.15 and 0.85 at | | |
| | around 100 micron | | |
| | thickness | | |
| C. | Greater than | Negatively | perfluorosulfonic acid |
| Cation- | approximately 1 | charged functional | polytetrafluoroethylene |
| conducting | mS/cm specific | groups are | co-polymer; |
| | conductivity for | covalently bound | sulfonated poly(ether |
| | cations, which have a | to the polymer | ketone); |
| | transference number | backbone | poly(styrene sulfonic |
| | greater than | | acid- co-maleic acid) |
| | approximately 0.85 at | | |
| | around 100 | | |
| | micron thickness | | |

Polymeric Structures

Examples of polymeric structures that can include an ionizable moiety or an ionic moiety and be used as ion-conducting polymers (ionomers) in the MEAs described here are provided below. The ion-conducting polymers may be used as appropriate in any of the MEA layers that include an ion-conducting polymer. Charge conduction through the material can be controlled by the type and amount of charge (e.g., anionic and/or cationic charge on the polymeric structure) provided by the ionizable/ionic moieties. In addition, the composition can include a polymer, a homopolymer, a copolymer, a block copolymer, a polymeric blend, other polymer-based forms, or other useful combinations of repeating monomeric units. As described below, an ion conducting polymer layer may include one or more of crosslinks, linking moieties, and arylene groups according to various embodiments. In some embodiments, two or more ion conducting polymers (e.g., in two or more ion conducting polymer layers of the MEA) may be crosslinked.

Non-limiting monomeric units can include one or more of the following:

[symbol] Ar [symbol] , [symbol] Ar-L [symbol] , [symbol] Ak [symbol] , or [symbol] Ak-L [symbol] , in which Ar is an optionally substituted arylene or aromatic; Ak is an optionally substituted alkylene, haloalkylene, aliphatic, heteroalkylene, or heteroaliphatic; and L is a linking moiety (e.g., any described herein) or can be —C(R⁷)(R⁸)—. Yet other non-limiting monomeric units can include optionally substituted arylene, aryleneoxy, alkylene, or combinations thereof, such as optionally substituted (aryl)(alkyl)ene (e.g., -Ak-Ar— or -Ak-Ar-Ak- or —Ar-Ak-, in which Ar is an optionally substituted arylene and Ak is an optionally substituted alkylene). One or more monomeric units can be optionally substituted with one or more ionizable or ionic moieties (e.g., as described herein).

One or more monomeric units can be combined to form a polymeric unit. Non-limiting polymeric units include any of the following: [symbol] Ar-L [symbol] ₙ, [symbol] Ar-L [symbol] ₙ [symbol] Ar-L [symbol] ₘ, [symbol] Ar-L [symbol] ₙ [symbol] Ak [symbol] ₘ, [symbol] L-Ar [symbol] ₙ [symbol] Ak [symbol] ₘ, [symbol] Ar-L [symbol] ₙ [symbol] Ak [symbol] ₘ [symbol] Ak [symbol] ₘ, [symbol] L-Ar [symbol] ₙ [symbol] Ak [symbol] ₘ [symbol] Ak [symbol] ₘ, [symbol] Ar-L [symbol] ₙ [symbol] Ak [symbol] ₘ [symbol] Ak [symbol] ₘ [symbol] Ar-L [symbol] ₙ, or [symbol] L-Ar [symbol] ₙ [symbol] Ak [symbol] ₘ [symbol] Ak [symbol] ₘ [symbol] L-Ar [symbol] ₙ, in which Ar, Ak, L, n, and m can be any described herein. In some embodiments, each m is independently 0 or an integer of 1 or more. In other embodiments, Ar can include two or more arylene or aromatic groups.

Other alternative configurations are also encompassed by the compositions herein, such as branched configurations, diblock copolymers, triblock copolymers, random or statistical copolymers, stereoblock copolymers, gradient copolymers, graft copolymers, and combinations of any blocks or regions described herein.

Examples of polymeric structures include those according to any one of formulas (I)-(V) and (X)-(XXXIV), or a salt thereof. In some embodiments, the polymeric structures are copolymers and include a first polymeric structure selected from any one of formulas (I)-(V) or a salt thereof; and a second polymeric structure including an optionally substituted aromatic, an optionally substituted arylene, a structure selected from any one of formulas (I)-(V) and (X)-(XXXIV), or a salt thereof.

In one embodiment, the MW of the ion-conducting polymer is a weight-average molecular weight (Mw) of at least 10,000 g/mol; or from about 5,000 to 2,500,000 g/mol. In another embodiment, the MW is a number average molecular weight (Mn) of at least 20,000 g/mol; or from about 2,000 to 2,500,000 g/mol.

In any embodiment herein, each of n, n1, n2, n3, n4, m, m1, m2, or m3 is, independently, 1 or more, 20 or more, 50 or more, 100 or more; as well as from 1 to 1,000,000, such as from 10 to 1,000,000, from 100 to 1,000,000, from 200 to 1,000,000, from 500 to 1,000,000, or from 1,000 to 1,000,000.

Non-limiting polymeric structures can include the following:

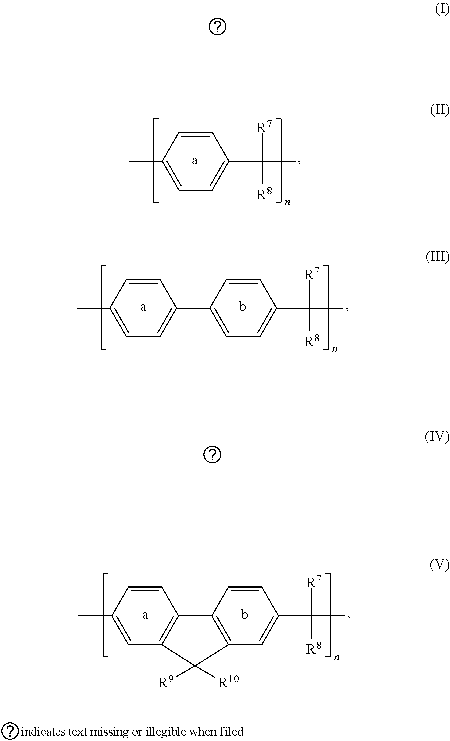

or a salt thereof, wherein:
each of R⁷, R⁸, R⁹, and R¹⁰ is, independently, an electron-withdrawing moiety, H, optionally substituted aliphatic, alkyl, heteroaliphatic, heteroalkylene, aromatic, aryl, or arylalkylene, wherein at least one of R⁷ or R⁸ can include the electron-withdrawing moiety or wherein a combination of R⁷ and R⁸ or R⁹ and R¹⁰ can be taken together to form an optionally substituted cyclic group;
Ar comprises or is an optionally substituted aromatic or arylene (e.g., any described herein);

each of n is, independently, an integer of 1 or more;

each of rings a-c can be optionally substituted; and
rings a-c, R⁷, R⁸, R⁹, and R¹⁰ can optionally comprise an ionizable or ionic moiety.

Further non-limiting polymeric structures can include one or more of the following:

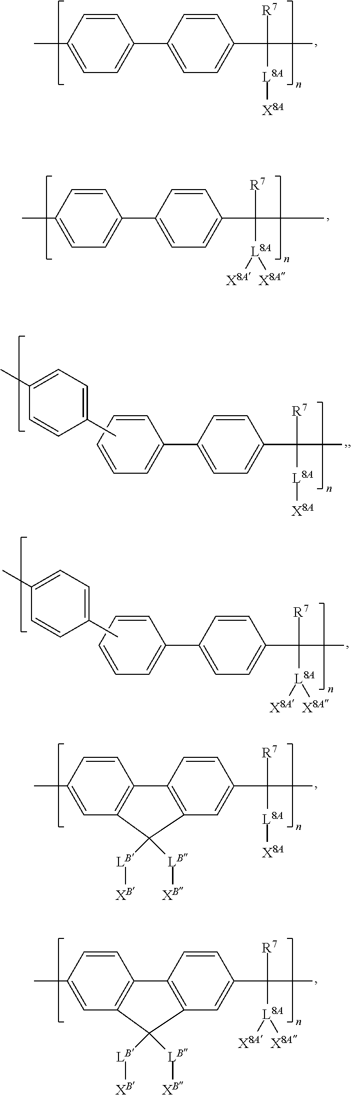

or a salt thereof, wherein:
R⁷ can be any described herein (e.g., for formulas (I)-(V));
n is from 1 or more;
each L^{8A}, L^{B′}, and L^{B″} is, independently, a linking moiety; and
each X^{8A}, X^{8A′}, X^{8A″}, X^{B′}, and X^{B″} is, independently, an ionizable or ionic moiety.

Yet other polymeric structures include the following:

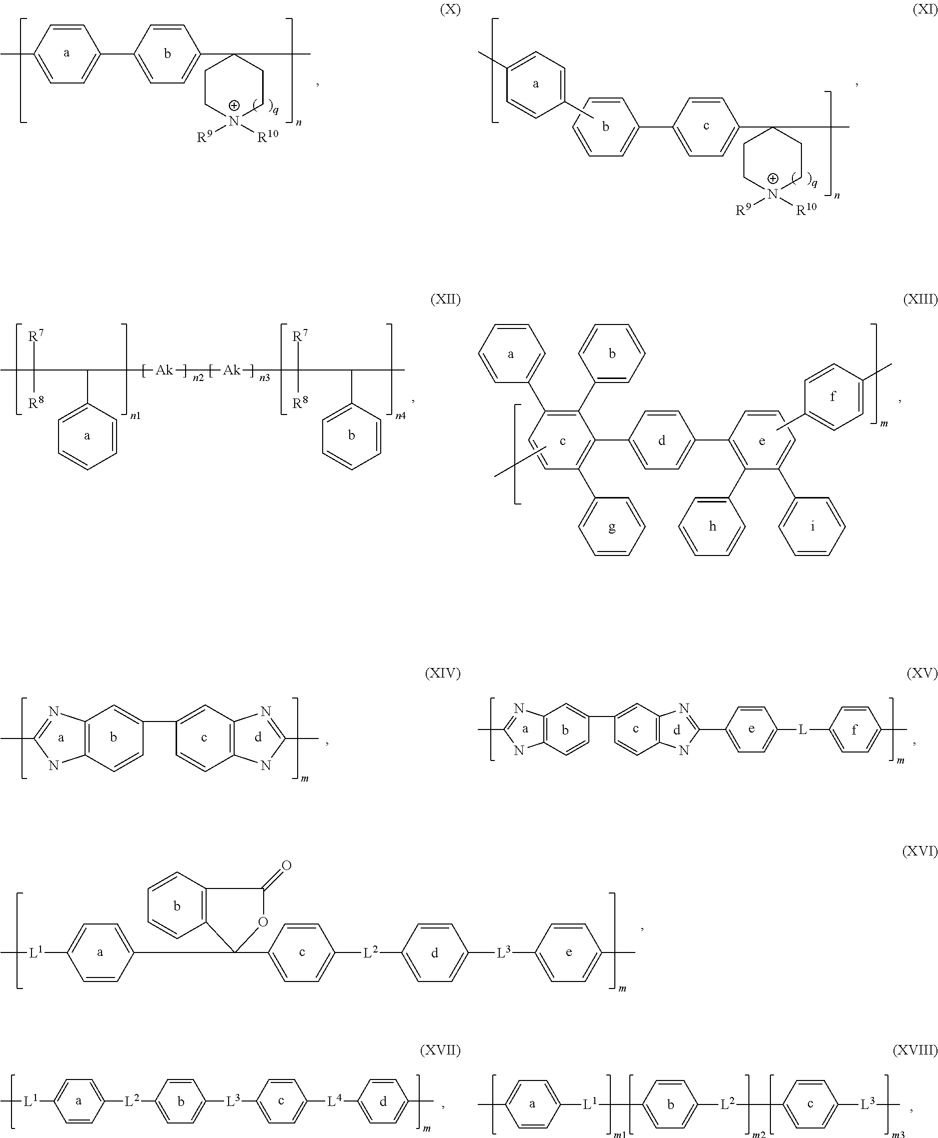

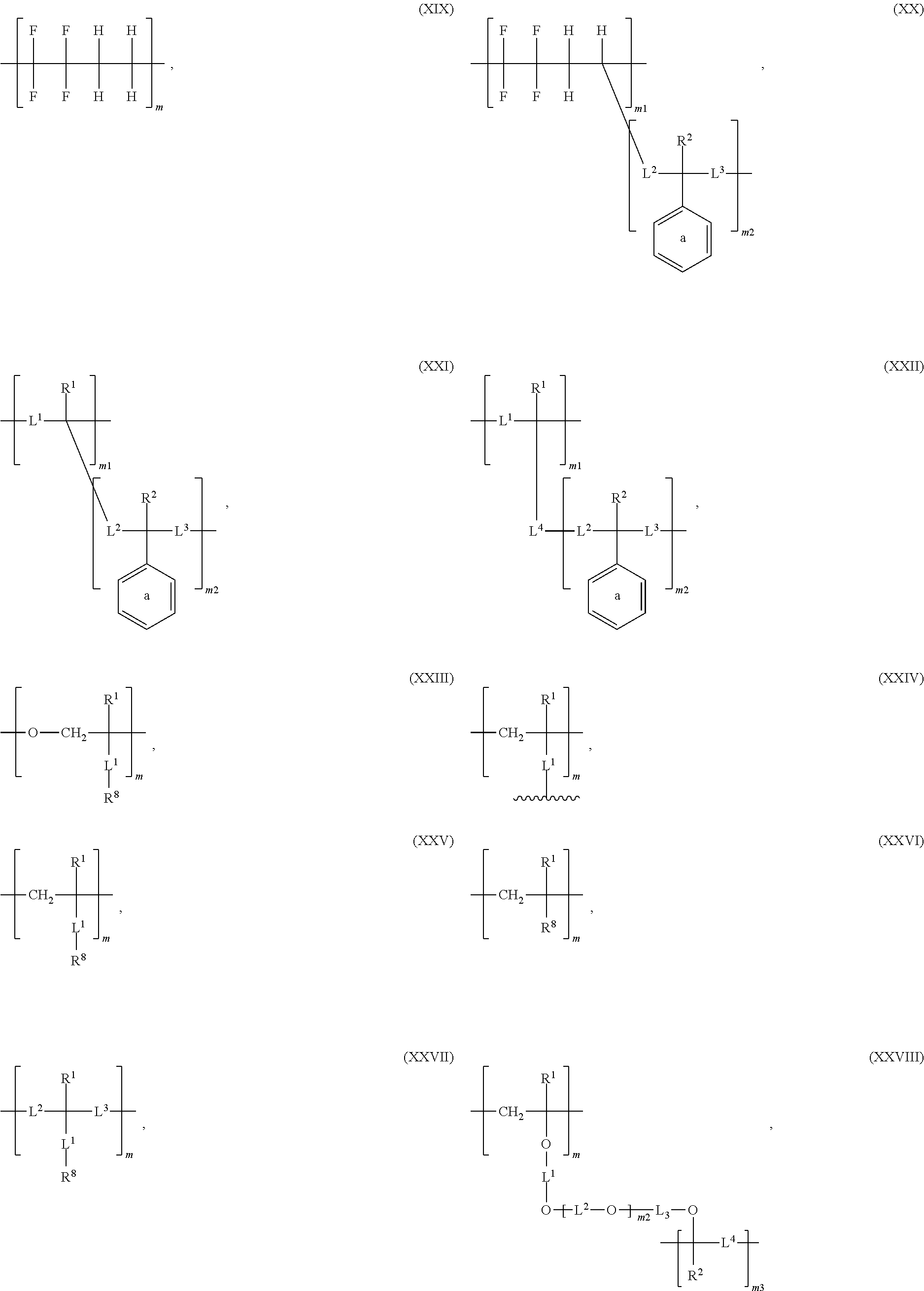

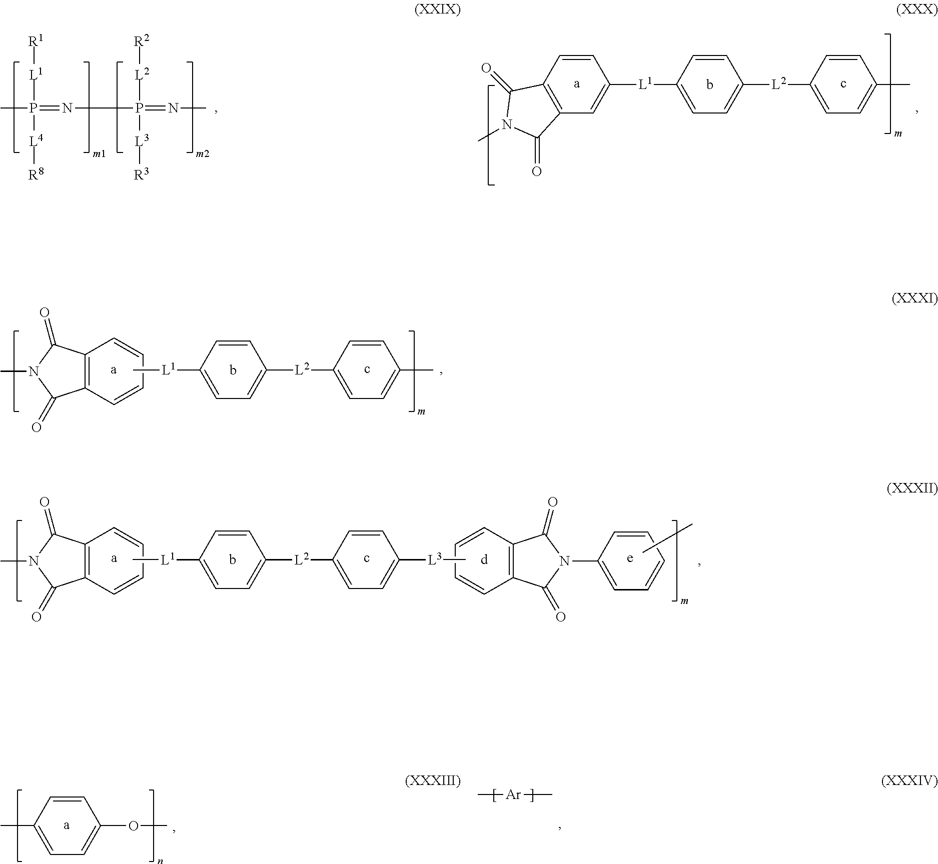

or a salt thereof, wherein:
each of R¹, R², R³, R⁷, R⁸, R⁹, and R¹⁰ is, independently, an electron-withdrawing moiety, H, optionally substituted aliphatic, alkyl, heteroaliphatic, heteroalkylene, aromatic, aryl, or arylalkylene, wherein at least one of R⁷ or R⁸ can include the electron-withdrawing moiety or wherein a combination of R⁷ and R⁸ or R⁹ and R¹⁰ can be taken together to form an optionally substituted cyclic group;
each Ak is or comprises an optionally substituted aliphatic, alkylene, haloalkylene, heteroaliphatic, or heteroalkylene;
each Ar is or comprises an optionally substituted arylene or aromatic;
each of L, L¹, L², L³, and L⁴ is, independently, a linking moiety;
each of n, n¹, n², n³, n⁴, m, m1, m2, and m3 is, independently, an integer of 1 or more;
q is 0, 1, 2, or more;
each of rings a-i can be optionally substituted; and
rings a-i, R⁷, R⁸, R⁹, and R¹⁰ can optionally include an ionizable or ionic moiety.

In particular embodiments (e.g., of formula (XIV) or (XV)), each of the nitrogen atoms on rings a and/or b are substituted with optionally substituted aliphatic, alkyl, aromatic, aryl, an ionizable moiety, or an ionic moiety. In some embodiments, one or more hydrogen or fluorine atoms (e.g., in formula (XIX) or (XX)) can be substituted to include an ionizable moiety or an ionic moiety (e.g., any described herein). In other embodiments, the oxygen atoms present in the polymeric structure (e.g., in formula XXVIII) can be associated with an alkali dopant (e.g., K⁺).

In particular examples, Ar, one or more of rings a-i (e.g., rings a, b, f, g, h, or i), L, L¹, L², L³, L⁴, Ak, R⁷, R⁸, R⁹, and/or R¹⁰ can be optionally substituted with one or more ionizable or ionic moieties and/or one or more electron-withdrawing groups. Yet other non-limiting substituents for Ar, rings (e.g., rings a-i), L, Ak, R⁷, R⁸, R⁹, and R¹⁰ include one or more described herein, such as cyano, hydroxy, nitro, and halo, as well as optionally substituted aliphatic, alkyl, alkoxy, alkoxyalkyl, amino, aminoalkyl, aryl, arylalkylene, aryloyl, aryloxy, arylalkoxy, hydroxyalkyl, and haloalkyl.

In some embodiments, each of R¹, R², and R³ is, independently, H, optionally substituted aromatic, aryl, aryloxy, or arylalkylene. In other embodiments (e.g., of formulas (I)-(V) or (XII)), R⁷ includes the electron-withdrawing moiety. In yet other embodiments, R⁸, R⁹, and/or R¹⁰ includes an ionizable or ionic moiety.

In one instance, a polymeric subunit can lack ionic moieties. Alternatively, the polymeric subunit can include an ionic moiety on the Ar group, the L group, both the Ar and L groups, or be integrated as part of the L group. Non-limiting examples of ionizable and ionic moieties include cationic, anionic, and multi-ionic group, as described herein.

In any embodiment herein, the electron-withdrawing moiety can include or be an optionally substituted haloalkyl, cyano (CN), phosphate (e.g., —O(P═O)(OR^{P1})(OR^{P2}) or —O— [P(═O)(OR^{P1})—O]_{P3}—R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (B(OH)₂), thiocyanato (—SCN), or piperidinium. Yet other non-limiting phosphate groups can include derivatives of phosphoric acid, such as orthophosphoric acid, pyrophosphoric acid, tripolyphosphoric acid, tetrapolyphosphoric acid, trimetaphosphoric acid, and/or phosphoric anhydride, or combinations thereof.

Yet other polymeric units can include poly(benzimidazole) (PBI), polyphenylene (PP), polyimide (PI), poly(ethyleneimine) (PEI), sulfonated polyimide (SPI), polysulfone (PSF), sulfonated polysulfone (SPSF), poly(ether ketone) (PEEK), PEEK with cardo groups (PEEK-WC), polyethersulfone (PES), sulfonated polyethersulfone (SPES), sulfonated poly(ether ketone) (SPEEK), SPEEK with cardo groups (SPEEK-WC), poly(p-phenylene oxide) (PPO), sulfonated polyphenylene oxide (SPPO), ethylene tetrafluoroethylene (ETFE), polytetrafluoroethylene (PTFE), poly(epichlorohydrin) (PECH), poly(styrene) (PS), sulfonated poly(styrene) (SPS), hydrogenated poly(butadiene-styrene) (HPBS), styrene divinyl benzene copolymer (SDVB), styrene-ethylene-butylene-styrene (SEBS), sulfonated bisphenol-A-polysulfone (SPSU), poly(4-phenoxy benzoyl-1,4-phenylene) (PPBP), sulfonated poly(4-phenoxy benzoyl-1,4-phenylene) (SPPBP), poly(vinyl alcohol) (PVA), poly(phosphazene), poly(aryloxyphosphazene), polyetherimide, as well as combinations thereof.

Bipolar MEA for COx Reduction

In certain embodiments, the MEA includes a bipolar interface having an anion-conducting polymer on the cathode side of the MEA and an interfacing cation-conducting polymer on the anode side of the MEA. In some implementations, the cathode contains a first catalyst and an anion-conducting polymer. In certain embodiments, the anode contains a second catalyst and a cation-conducting polymer. In some implementations, a cathode buffer layer, located between the cathode and PEM, contains an anion-conducting polymer. In some embodiments, an anode buffer layer, located between the anode and PEM, contains a cation-conducting polymer.

In embodiments employing an anion-conducting polymer in the cathode and/or in a cathode buffer layer, the MEA can decrease or block unwanted reactions that produce undesired products and decrease the overall efficiency of the cell. In embodiments employing a cation-conducting polymer in the anode and/or in an anode buffer layer can decrease or block unwanted reactions that reduce desired product production and reduce the overall efficiency of the cell.

For example, at levels of electrical potential used for cathodic reduction of CO₂, hydrogen ions may be reduced to hydrogen gas. This is a parasitic reaction; current that could be used to reduce CO₂ is used instead to reduce hydrogen ions. Hydrogen ions may be produced by various oxidation reactions performed at the anode in a CO₂ reduction reactor and may move across the MEA and reach the cathode where they can be reduced to produce hydrogen gas. The extent to which this parasitic reaction can proceed is a function of the concentration of hydrogen ions present at the cathode. Therefore, an MEA may employ an anion-conducting material in the cathode layer and/or in a cathode buffer layer. The anion-conducting material at least partially blocks hydrogen ions from reaching catalytic sites on the cathode. As a result, parasitic production of hydrogen gas decreases and the rate of production of CO or other carbon-containing product increases.

Another reaction that may be avoided is reaction of carbonate or bicarbonate ions at the anode to produce CO₂. Aqueous carbonate or bicarbonate ions may be produced from CO₂ at the cathode. If such ions reach the anode, they may react with hydrogen ions to produce and release gaseous CO₂. The result is net movement of CO₂ from the cathode to the anode, where it does not get reduced and is lost with oxidation products. To prevent the carbonate and bicarbonate ion produced at the cathode from reaching the anode, the anode and/or an anode buffer layer may include a cation-conducting polymer, which at least partially blocks the transport of negative ions such as bicarbonate ions to the anode.

Thus, in some designs, a bipolar membrane structure raises the pH at the cathode to facilitate CO₂ reduction while a cation-conducting polymer such as a proton-exchange layer prevents the passage of significant amounts of CO₂ and CO₂ reduction products (e.g., bicarbonate) to the anode side of the cell.

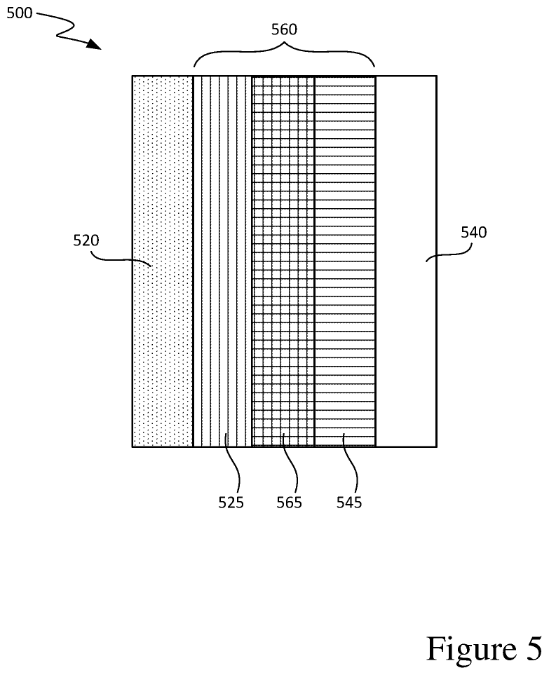

An example MEA 500 for use in COₓ reduction is shown in FIG. 5. The MEA 500 has a cathode layer 520 and an anode layer 540 separated by an ion-conducting polymer layer 560 that provides a path for ions to travel between the cathode layer 520 and the anode layer 540. In certain embodiments, the cathode layer 520 includes an anion-conducting polymer and/or the anode layer 540 includes a cation-conducting polymer. In certain embodiments, the cathode layer and/or the anode layer of the MEA are porous. The pores may facilitate gas and/or fluid transport and may increase the amount of catalyst surface area that is available for reaction.

The ion-conducting layer 560 may include two or three sublayers: a polymer electrolyte membrane (PEM) 565, an optional cathode buffer layer 525, and/or an optional anode buffer layer 545. One or more layers in the ion-conducting layer may be porous. In certain embodiments, at least one layer is nonporous so that reactants and products of the cathode cannot pass via gas and/or liquid transport to the anode and vice versa. In certain embodiments, the PEM layer 565 is nonporous. Example characteristics of anode buffer layers and cathode buffer layers are provided elsewhere herein. In certain embodiments, the ion-conducting layer includes only a single layer or two sublayers.

In some embodiments, a carbon oxide electrolyzer anode contains a blend of oxidation catalyst and an ion-conducting polymer. There are a variety of oxidation reactions that can occur at the anode depending on the reactant that is fed to the anode and the anode catalyst(s). In one arrangement, the oxidation catalyst is selected from the group consisting of metals and oxides of Ir, Pt, Ni, Ru, Pd, Au, and alloys thereof, IrRu, PtIr, Ni, NiFe, stainless steel, and combinations thereof. The oxidation catalyst can further contain conductive support particles such as carbon, boron-doped diamond, titanium, and any combination thereof.

As examples, the oxidation catalyst can be in the form of a structured mesh or can be in the form of particles. If the oxidation catalyst is in the form of particles, the particles can be supported by electronically conductive support particles. The conductive support particles can be nanoparticles. The conductive support particles may be compatible with the chemicals that are present in an electrolyzer anode when the electrolyzer is operating and are oxidatively stable so that they do not participate in any electrochemical reactions. It is especially useful if the conductive support particles are chosen with the voltage and the reactants at the anode in mind. In some arrangements, the conductive support particles are titanium, which is well-suited for high voltages. In other arrangements, the conductive support particles are carbon, which can be most useful at low voltages. In some embodiments, such conductive support particles are larger than the oxidation catalyst particles, and each conductive support particle can support one or more oxidation catalyst particles. In one arrangement, the oxidation catalyst is iridium ruthenium oxide. Examples of other materials that can be used for the oxidation catalyst include, but are not limited to, those listed above. It should be understood that many of these metal catalysts can be in the form of oxides, especially under reaction conditions.

As mentioned, in some embodiments, an anode layer of an MEA includes an ion-conducting polymer. In some cases, this polymer contains one or more covalently bound, negatively charged functional groups configured to transport mobile positively charged ions. Examples of the second ion-conducting polymer include ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene, tetrafluoroethylene-perfluoro-3,6-dioxa-4-methyl-7-octenesulfonic acid copolymer, other perfluorosulfonic acid polymers and blends thereof. Commercially available examples of cation-conducting polymers include e.g., Nafion 115, Nafion 117, and/or Nafion 211. Other examples of cationic conductive ionomers described above are suitable for use in anode layers.

There may be tradeoffs in choosing the amount of ion-conducting polymer in the anode. For example, an anode may include enough anode ion-conducting polymer to provide sufficient ionic conductivity, while being porous so that reactants and products can move through it easily. An anode may also be fabricated to maximize the amount of catalyst surface area that is available for reaction. In various arrangements, the ion-conducting polymer in the anode makes up about 10 and 90 wt %, or about 20 and 80 wt %, or about 25 and 70 wt % of the total anode mass. As an example, the ion-conducting polymer may make up about 5 and 20 wt % of the anode. In certain embodiments, the anode may be configured to tolerate relatively high voltages, such as voltages above about 1.2 V vs. a reversible hydrogen electrode. In some embodiments, an anode is porous in order to maximize the amount of catalyst surface area available for reaction and to facilitate gas and liquid transport.

In one example of a metal catalyst, Ir or IrOx particles (100-200 nm) and Nafion ionomer form a porous layer approximately 10 μm thick. Metal catalyst loading is approximately 0.5-3 g/cm². In some embodiments, NiFeOx is used for basic reactions.

In some embodiments, the MEA and/or the associated cathode layer is designed or configured to accommodate gas generated in situ. Such gas may be generated via various mechanisms. For example, carbon dioxide may be generated when carbonate or bicarbonate ions moving from the cathode toward the anode encounter hydrogen ions moving from the anode toward the cathode. This encounter may occur, for example, at the interface of anionic and cationic conductive ionomers in a bipolar MEA. Alternatively, or in addition, such contact may occur at the interface of a cathode layer and a polymer electrolyte membrane. For example, the polymer electrolyte membrane may contain a cationic conductive ionomer that allows transport of protons generated at the anode. The cathode layer may include an anion conductive ionomer.

Left unchecked, the generation of carbon dioxide or other gas may cause the MEA to delaminate or otherwise be damaged. It may also prevent a fraction of the reactant gas from being reduced at the anode.

The location within or adjacent to an MEA where a gas such as carbon dioxide is generated in situ may contain one or more structures designed to accommodate such gas and, optionally, prevent the gas from reaching the anode, where it would be otherwise unavailable to react.

In certain embodiments, pockets or voids are provided at a location where the gas is generated. These pockets or voids may have associated pathways that allow the generated gas to exit from the MEA, optionally to the cathode where, for example, carbon dioxide can be electrochemically reduced. In certain embodiments, an MEA includes discontinuities at an interface of anionic and cationic conductive ionomer layers such as at such interface in a bipolar MEA. In some embodiments, a cathode structure is constructed in a way that includes pores or voids that allow carbon dioxide generated at or proximate to the cathode to evacuate into the cathode.

In some embodiments, such discontinuities or void regions are prepared by fabricating in MEA in a way that separately fabricates anode and cathode structures, and then sandwiches to the two separately fabricated structures together in a way that produces the discontinuities or voids.

In some embodiments, and MEA structure is fabricated by depositing copper or other catalytic material onto a porous or fibrous matrix such as a fluorocarbon polymer and then coating the resulting structure with an anionic conductive ionomer. In some embodiments, the coated structure is then attached to the remaining MEA structure, which may include an anode and a polymer electrolyte membrane such as a cationic conductive membrane.

In some embodiments, a cathode has a porous structure and the/or an associated cathode buffer layer that has a porous structure. The pores may be present in an open cell format that allows generated carbon dioxide or other gas to find its way to the cathode.

In some MEAs, an interface between an anion conducting layer and a cation conducting layer (e.g., the interface of a cathode buffer layer and a PEM) includes a feature that resists delamination caused by carbon dioxide, water, or other material that may form at the interface. In some embodiments, the feature provides void space for the generated material to occupy until as it escapes from an MEA. In some examples, natural porosity of a layer such as an anion conducting layer provides the necessary void space. An interconnected network of pores may provide an escape route for carbon dioxide or other gas generated at the interface. In some embodiments, an MEA contains interlocking structures (physical or chemical) at the interface. In some embodiments, an MEA contains discontinuities at the interface. In some embodiments, an MEA contains of a fibrous structure in one layer adjacent the interface. A further discussion of interfacial structures between anion and cation conducting layers of MEAs is contained in Published PCT Application No. 2021/108446, published Jun. 3, 2021, and titled “MEMBRANE ELECTRODE ASSEMBLY FOR COX REDUCTION,” which is incorporated herein by reference in its entirety.

### Other Embodiments and Conclusion

Although omitted for conciseness, embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

What is claimed is:

1. A system comprising:
(a) a first outer electrode of a first polarity;
(b) a CO₂ purifier comprising:
(i) an inlet for receiving impure CO_{2,}
(ii) the first outer electrode configured to apply an electrical potential of a first polarity,
(iii) a medium that selectively captures and/or removes CO₂ under the influence of a positive electrical potential or a negative electrical potential, and
(iv) an outlet for removing purified CO₂;
(c) a second outer electrode configured to apply an electrical potential of a second polarity, opposite the first polarity;
(d) a CO₂ electrolyzer configured to receive the purified CO₂ from the CO₂ purifier, the CO₂ electrolyzer comprising:
(i) an inlet for receiving the purified CO₂,
(ii) the second outer electrode, and
(iii) a cathode catalyst configured to electrochemically reduce CO₂ to produce a carbon containing product; and
(e) a bipolar plate separating the CO₂ purifier from the CO₂ electrolyzer and arranged to provide (i) a first bipolar electrode surface of the second polarity for the CO₂ purifier, and (ii) a second bipolar electrode surface of the first polarity for the CO₂ electrolyzer.

2. The system of claim 1, wherein the bipolar plate does not have an electrical connection to an external circuit or load.

3. The system of claim 1, wherein the CO₂ purifier is configured to produce the purified CO₂ while electrical energy is supplied to the first outer electrode and the second outer electrode.

4. The system of claim 3, wherein the CO₂ purifier is configured to continuously produce the purified CO₂.

5. The system of claim 1, wherein the CO₂ purifier comprises a plurality of parallel liquid flow paths between the bipolar plate and the first outer electrode, wherein the plurality of parallel liquid flow paths comprise:
a carbonate donating flow path configured to flow a first solution containing carbonate and/or bicarbonate ions wherein the carbonate donating flow path is bounded on a first side by an anion exchange membrane, and
a carbonate receiving flow path arranged adjacent to said carbonate donating flow path and configured to flow a second solution that is more acidic than the first solution, wherein the carbonate receiving flow path is bounded by said anion exchange membrane that allows the carbonate and/or bicarbonate ions to pass from the carbonate donating flow path to the carbonate receiving flow path, and
wherein the medium comprises the first solution and/or the second solution.

6. The system of claim 5, wherein the carbonate donating flow path is bounded on a second side by a bipolar membrane.

7. The system of claim 5, wherein the carbonate receiving flow path is bounded by a bipolar membrane.

8. The system of claim 5, wherein the plurality of parallel liquid flow paths further comprise:
a second carbonate donating flow path configured to flow the first solution; and
a second carbonate receiving flow path arranged adjacent to said second carbonate donating flow path and configured to flow the second solution.

9. The system of claim 5, further comprising a first solution tank configured to supply the first solution to the carbonate donating flow path and a recycle path configured to recycle the first solution from the carbonate donating flow path to the first solution tank.

10. The system of claim 5, further comprising a second solution tank configured to supply the second solution to the carbonate receiving flow path and a recycle path configured to recycle the second solution from the carbonate receiving flow path to the second solution tank.

11. The system of claim 1, wherein the CO₂ purifier comprises
one or more flow paths configured transport a compound comprising one or more electroactive CO₂-absorbing moieties between an anode region and a cathode region, and
a controller configured to
apply a cathodic potential and/or flow a cathodic current to the cathode region to thereby cause the compound to absorb CO₂ from the impure CO₂,
apply an anodic potential and/or flow an anodic current to the anode region to thereby cause the compound to release CO₂ and produce the purified CO₂, and
cause the compound to move between the cathode region and the anode region.

12. The system of claim 11, wherein the CO₂ purifier further comprises a separator between the cathode region and the anode region.

13. The system of claim 11, wherein the compound comprises one or more electroactive CO₂-absorbing moieties is a polymer.

14. The system of claim 11, wherein the one or more CO₂-absorbing moieties comprise quinone moieties.

15. The system of claim 1, wherein the CO₂ electrolyzer comprises a membrane electrode assembly (MEA).

16. The system of claim 15, wherein the MEA comprises an anion conducting polymer membrane.

17. The system of claim 16, wherein the MEA further comprises a cation conducting polymer membrane in contact with the anion conducting polymer membrane.

18. The system of claim 1, wherein the carbon containing product comprises CO, a hydrocarbon, formic acid, an alcohol, or any combination thereof.

19. The system of claim 1, further comprising a controller configured to cause electrical energy to be applied to the first outer electrode and the second outer electrode and thereby cause:
the CO₂ purifier to produce the purified CO₂, and
the cathode catalyst to electrochemically reduce the purified CO₂ to produce the carbon containing product.

20. The system of claim 1, wherein the purified CO₂ has a concentration of at least about 20% by volume.

21. A method of electrochemically reducing CO₂ to a carbon containing product using a system comprising (a) a first outer electrode of a first polarity, (b) a second outer electrode of a second polarity, opposite the first polarity, (c) a CO₂ purifier having the first outer electrode as a CO₂ purifier anode or cathode, (d) a CO₂ electrolyzer having the second outer electrode as a CO₂ electrolyzer anode or cathode, and (e) a bipolar plate separating the CO₂ purifier from the CO₂ electrolyzer and arranged to provide (i) a first bipolar electrode surface of the second polarity for the CO₂ purifier, and (ii) a second bipolar electrode surface of the first polarity for the CO₂ electrolyzer, the method comprising:
receiving impure CO₂ in the CO₂ purifier;
selectively capturing and/or removing CO₂ under the influence of a positive electrical field or a negative electrical field in the CO₂ purifier;
providing purified CO₂ from the CO₂ purifier to the CO₂ electrolyzer; and
electrochemically reducing the purified CO₂ in the CO₂ electrolyzer to produce a carbon containing product.

22. The method of claim 21, wherein the bipolar plate does not have an electrical connection to an external circuit or load.

23. The method of claim 21, wherein selectively capturing and/or removing CO₂ comprises supplying electrical energy to the first outer electrode and the second outer electrode.

24. The method of claim 23, wherein the CO₂ purifier continuously provides the purified CO₂ to the CO₂ electrolyzer.

25. The method of claim 21, wherein the CO₂ purifier comprises a plurality of parallel liquid flow paths between the bipolar plate and the first outer electrode, wherein the plurality of parallel liquid flow paths comprise:
a carbonate donating flow path that flows a first solution containing carbonate and/or bicarbonate ions and is bounded on a first side by an anion exchange membrane, and
a carbonate receiving flow path adjacent to said carbonate donating flow path and flows a second solution that is more acidic than the first solution, wherein the carbonate receiving flow path is bounded by said anion exchange membrane that allows the carbonate and/or bicarbonate ions to pass from the carbonate donating flow path to the carbonate receiving flow path.

26. The method of claim 25, wherein the carbonate donating flow path is bounded on a second side by a bipolar membrane.

27. The method of claim 25, wherein the carbonate receiving flow path is bounded by a bipolar membrane.

28. The method of claim 25, wherein the plurality of parallel liquid flow paths further comprise:
a second carbonate donating flow path configured to flow the first solution; and
a second carbonate receiving flow path arranged adjacent to said second carbonate donating flow path and configured to flow the second solution.

29. The method of claim 25, further comprising:
supplying the first solution to the carbonate donating flow path from a first solution tank; and
recycling the first solution from the carbonate donating flow path to the first solution tank.

30. The method of claim 25, further comprising:
supplying the second solution to the carbonate receiving flow path from a second solution tank; and
recycling the second solution from the carbonate receiving flow path to the second solution tank.

31. The method of claim 21, further comprising:
transporting a compound comprising one or more electroactive CO₂-absorbing moieties between an anode region of the CO₂ purifier and a cathode region of the CO₂ purifier;
applying a cathodic potential and/or flowing a cathodic current to the cathode region to thereby cause the compound to absorb CO₂ from the impure CO₂;
applying an anodic potential and/or flowing an anodic current to the anode region to thereby cause the compound to release CO₂ and produce the purified CO₂; and
moving the compound between the cathode region and the anode region.

32. The method of claim 31, wherein the CO₂ purifier further comprises a separator between the cathode region and the anode region.

33. The method of claim 31, wherein the compound comprises one or more electroactive CO₂-absorbing moieties is a polymer.

34. The method of claim 31, wherein the one or more CO₂-absorbing moieties comprise quinone moieties.

35. The method of claim 21, wherein the CO₂ electrolyzer comprises a membrane electrode assembly (MEA).

36. The method of claim 35, wherein the MEA comprises an anion conducting polymer membrane.

37. The method of claim 36, wherein the MEA further comprises a cation conducting polymer membrane in contact with the anion conducting polymer membrane.

38. The method of claim 21, wherein the carbon containing product comprises CO, a hydrocarbon, formic acid, an alcohol, or any combination thereof.

39. The method of claim 21, further comprising:
applying electrical energy to the first outer electrode and the second outer electrode and thereby cause:
the CO₂ purifier to produce the purified CO₂, and the CO₂ electrolyzer to electrochemically reduce the purified CO₂ to produce the carbon containing product.

40. The method of claim 21, wherein the purified CO₂ has a concentration of at least about 20% by volume.
